(19) United States
(12) Patent Application Publication
(10) Pub. No.: US 2026/0233106 A1
(43) Pub. Date: Aug. 13, 2026

(54) Virtual Resource Allocation Method and Apparatus, Device, Storage Medium, and Program Product

(71) Applicant: Tencent Technology (Shenzhen) Company Limited, Shenzhen (CN)

(72) Inventors: Kai Wang, Shenzhen (CN); Jianzhao Chen, Shenzhen (CN); Yibo Yue, Shenzhen (CN); Haiyang Dong, Shenzhen (CN)

(21) Appl. No.: 19/637,408

(22) Filed: Apr. 2, 2026

Related U.S. Application Data
(63) Continuation of application No. PCT/CN2025/077175, filed on Feb. 13, 2025.

(30) Foreign Application Priority Data
Feb. 20, 2024 (CN) 2024101921943

(51) Int. Cl. A63F 13/70; A63F 13/55

(52) U.S. Cl. CPC A63F 13/70; A63F 13/55

(57) ABSTRACT

Provided are a virtual resource obtaining method and apparatus, a device, a storage medium, and a program product, which relate to the field of virtual environments. The method includes: displaying a resource redemption prop in a virtual scene; controlling, in response to a prop obtaining operation, a player-controlled virtual object to obtain the resource redemption prop, and displaying position information of a resource redemption point; controlling, in response to an object movement operation, the player-controlled virtual object carrying the resource redemption prop to move to the resource redemption point indicated by the position information; and displaying a resource redemption result in response to a resource redemption operation performed by the player-controlled virtual object at the resource redemption point.

### RELATED APPLICATIONS

This application claims priority to PCT/CN2025/077175, filed on February 13, 2025, which claims priority to Chinese Patent Application No. 202410192194.3, entitled "REWARD OBTAINING METHOD AND APPARATUS, DEVICE, STORAGE MEDIUM, AND PROGRAM PRODUCT" filed on February 20, 2024, each of which is incorporated herein by reference in its entirety.

### FIELD OF THE TECHNOLOGY

This application relates to the field of virtual environments, and in particular, to a reward obtaining method and apparatus, a device, a storage medium, and a program product.

### BACKGROUND OF THE DISCLOSURE

With the improvement of cultural and entertainment living standards, people have increasingly higher expectations for life experiences in the virtual world. As a manifestation of the virtual world, games have become a channel for many to release stress.

In the related art, a player and an opponent virtual object may jointly participate in a virtual match to perform a process of contending for game resources. In a game process, a plurality of players participating in the virtual match may contend for competitive virtual items in the virtual match, to obtain virtual resource rewards based on the virtual items after the virtual match ends.

In the foregoing process, a manner in which a player-controlled virtual object obtains virtual resource rewards is relatively monotonous and the method of obtaining rewards is subject to significant limitations. This can easily lead to a reduction in the appeal of a game, subsequently resulting in lower human-computer interaction efficiency.

### SUMMARY

This application provides a reward obtaining method and apparatus, a device, a storage medium, and a program product, to endow a resource redemption prop with a new prop function. By controlling a player-controlled virtual object to interact with a resource redemption point to obtain a prop-holding reward, the appeal of a game is improved, gameplay is enriched, and human-computer interaction efficiency is enhanced. Technical solutions are provided below.

According to an aspect, a method is provided. The method includes: displaying a resource redemption prop in a virtual scene, the resource redemption prop being configured for obtaining a prop-holding reward after redemption; controlling, in response to a prop obtaining operation, a player-controlled virtual object to obtain the resource redemption prop, and displaying position information of a resource redemption point; after the resource redemption prop is obtained, displaying prompt information from the perspective of an opponent virtual object, the prompt information being configured for prompting the opponent virtual object to contend for ownership of the resource redemption prop; controlling, in response to an object movement operation, the player-controlled virtual object carrying the resource redemption prop to move to the resource redemption point indicated by the position information; and displaying a resource redemption result in response to a resource redemption operation performed by the player-controlled virtual object at the resource redemption point, the resource redemption result indicating reward information obtained by the player-controlled virtual object by redeeming the resource redemption prop.

According to another aspect, an apparatus is provided. The apparatus includes: a prop display module, configured to display a resource redemption prop in a virtual scene, the resource redemption prop being configured for obtaining a prop-holding reward after redemption; an information display module, configured to control, in response to a prop obtaining operation, a player-controlled virtual object to obtain the resource redemption prop, and display position information of a resource redemption point, after the resource redemption prop is obtained, display prompt information from the perspective of an opponent virtual object, the prompt information being configured for prompting the opponent virtual object to contend for ownership of the resource redemption prop; an operation receiving module, configured to control, in response to an object movement operation, the player-controlled virtual object carrying the resource redemption prop to move to the resource redemption point indicated by the position information; and a result display module, configured to display a resource redemption result in response to a resource redemption operation performed by the player-controlled virtual object at the resource redemption point, the resource redemption result indicating reward information obtained by the player-controlled virtual object by redeeming the resource redemption prop.

According to another aspect, a computer device is provided. The computer device includes a processor and a memory. The memory has at least one program stored therein. The at least one program is loaded and executed by the processor to implement the method according to any one of the examples of this application.

According to another aspect, a computer-readable storage medium is provided. The storage medium has at least one program stored therein. The at least one program is loaded and executed by a processor to implement the method according to any one of the examples of this application.

According to another aspect, a computer program product or a computer program is provided. The computer program product or the computer program includes computer instructions. The computer instructions are stored in a computer-readable storage medium. A processor of a computer device reads the computer instructions from the computer-readable storage medium, and executes the computer instructions, to cause the computer device to perform the method according to any one of the examples.

The technical solutions provided in the examples of this application achieve at least the following beneficial effects:

The resource redemption prop configured for redeeming for the prop-holding reward is displayed in the virtual scene; after the prop obtaining operation is received, the player-controlled virtual object is controlled to obtain the resource redemption prop, and the position information of the resource redemption point is displayed, after the resource redemption prop is obtained, display the prompt information from the perspective of the opponent virtual object, to prompt the opponent virtual object to contend for the ownership of the resource redemption prop; in response to the object movement operation, the player-controlled virtual object carrying the resource redemption prop is controlled to move to the resource redemption point; and the resource redemption result is displayed after the resource redemption point receives the resource redemption operation. The resource redemption prop is endowed with a new prop function. When the player-controlled virtual object possesses the ownership of the resource redemption prop, by controlling the player-controlled virtual object to interact with the resource redemption point, the prop-holding reward corresponding to the resource redemption prop may be directly obtained in a virtual match. Compared with the related art in which the prop-holding reward can only be obtained after extraction from or completion of the virtual match, this application can improve efficiency of obtaining the prop-holding reward, and improve human-computer interaction efficiency. In addition, in the process, the prompt information is displayed from the perspective of the opponent virtual object, whereby information accessibility is improved. Furthermore, in the process, the opponent virtual object may contend with the player-controlled virtual object for the ownership of the resource redemption prop, whereby difficulty in obtaining the prop-holding reward can be adjusted, the appeal of a game is improved, and gameplay is enriched. This facilitates efficient progress of a virtual match between different players, and further improves human-computer interaction efficiency.

### BRIEF DESCRIPTION OF THE DRAWINGS

To describe the technical solutions of the examples of this application more clearly, the following briefly introduces the accompanying drawings required for describing the examples. Apparently, the accompanying drawings in the following description show only some examples of this application, and a person of ordinary skill in the art may still derive other drawings from these accompanying drawings without creative efforts.

FIG. 1 is a structural block diagram of an electronic device according to an exemplary example of this application.

FIG. 2 is a structural block diagram of a computer system according to an exemplary example of this application.

FIG. 3 is a flowchart of a reward obtaining method according to an exemplary example of this application.

FIG. 4 is a flowchart of a reward obtaining method according to another exemplary example of this application.

FIG. 5 is a schematic diagram of an interface showing prop occurrence prompt information according to an exemplary example of this application.

FIG. 6 is a schematic diagram of an interface showing a prop position of a resource redemption prop on a virtual map according to an exemplary example of this application.

FIG. 7 is a schematic diagram of an interface displaying a resource redemption point according to an exemplary example of this application.

FIG. 8 is a schematic diagram of an interface showing that a player-controlled virtual object obtains a resource redemption prop according to an exemplary example of this application.

FIG. 9 is a schematic diagram of an interface displaying configuration prompt information for prop obtaining prompt information according to an exemplary example of this application.

FIG. 10 is a schematic diagram of displaying position information of a resource redemption point on a virtual map according to an exemplary example of this application.

FIG. 11 is a schematic diagram of an interface showing that an opponent virtual object determines a player-controlled virtual object based on a prop identifier displayed on a terminal interface of the opponent virtual object according to an exemplary example of this application.

FIG. 12 is a schematic diagram of an interface showing that a player-controlled virtual object is controlled to interact with a prop verification container according to an exemplary example of this application.

FIG. 13 is a flowchart of a reward obtaining method according to an exemplary example of this application.

FIG. 14 is a schematic diagram of an interface showing a teammate virtual object performs a prop duplication operation within a preset time period of a resource obtaining countdown according to an exemplary example of this application.

FIG. 15 is a schematic diagram of an interface showing that a prop identifier is fixed at a position of a prop verification container on a virtual map according to an exemplary example of this application.

FIG. 16 is a schematic diagram of an interface of an opponent virtual object according to an exemplary example of this application.

FIG. 17 is a schematic diagram of an interface of a teammate of an opponent virtual object according to an exemplary example of this application.

FIG. 18 is a schematic diagram of an interface showing that broadcast content is displayed on an interface of a player-controlled virtual object according to an exemplary example of this application.

FIG. 19 is a flowchart of a reward obtaining method according to another exemplary example of this application.

FIG. 20 is a schematic diagram of an interface showing prompt information according to an exemplary example of this application.

FIG. 21 is a general flowchart of an overall game according to an exemplary example of this application.

FIG. 22 is a schematic diagram of a technical side according to an exemplary example of this application.

FIG. 23 is a schematic diagram of a random template according to an exemplary example of this application.

FIG. 24 is a schematic diagram of a resource redemption point in a random template according to an exemplary example of this application.

FIG. 25 is a flowchart of stage determination according to an exemplary example of this application.

FIG. 26 is a structural block diagram of a reward obtaining apparatus according to an exemplary example of this application.

FIG. 27 is a structural block diagram of an electronic device according to an exemplary example of this application.

### DESCRIPTION OF EXAMPLES

First, several terms involved in examples of this application are briefly introduced.

Virtual scene: It refers to a virtual scene displayed (or provided) when an application program is run on a terminal. The virtual scene may be a simulation scene of a real world, or a semi-simulated and semi-fictional scene, or a purely fictional scene. The virtual scene may be any one of a two-dimensional virtual scene, a 2.5-dimensional virtual scene or a three-dimensional virtual scene. This is not limited in this application. A description is made by using an example in which the virtual scene is a three-dimensional virtual scene in the following examples.

Virtual model: It refers to a model in a virtual scene for simulating a real scene. For example, the virtual model occupies a volume in the virtual scene. For example, the virtual model includes: a terrain model, a building model, an animal/plant model, a virtual prop model, a virtual vehicle model, and a virtual object model. For example, the terrain model includes: a ground, a mountain, a water stream, a stone, a step, and the like. The building model includes: a house, a wall, a container, and fixed facilities inside a building: a desk/chair, a cabinet, a bed, and the like. The animal/plant model includes: a tree, a flower, a flying bird, and the like. The virtual prop model includes: a virtual attack prop, a medical kit, an airdrop, and the like. The virtual vehicle model includes: an automobile, a ship, a helicopter, and the like. The virtual object model includes: a person, an animal, an animated person, and the like.

Virtual object: It refers to a movable object in a virtual scene. The movable object may be a virtual object, a virtual animal, an animated person, or the like, such as a person, animal, plant, oil barrel, wall, or stone displayed in a three-dimensional virtual scene. In an example, the virtual object is a three-dimensional spatial model created based on a skeletal animation technology. Each virtual object has its own shape and volume in a three-dimensional virtual scene, and occupies a portion of space in the three-dimensional virtual scene.

In the related art, a player and an opponent virtual object may jointly participate in a virtual match to perform a process of contending for game resources. In a game process, a plurality of players participating in the virtual match may contend for competitive virtual items in the virtual match, to obtain special virtual resource rewards based on the virtual items. In the foregoing process, usually, after the player controls a player-controlled virtual object to secure the virtual item, another player determines a position of the player-controlled virtual object based on the virtual item and launches an attack on the player-controlled virtual object. Consequently, the player-controlled virtual object is usually in a passive state and cannot flexibly respond to the attack launched by the opponent virtual object on the player-controlled virtual object. This absence of an effective game balancing mechanism diminishes the appeal of a game, and results in lower human-computer interaction efficiency.

In examples of this application, a reward obtaining method is provided, to endow a resource redemption prop with a new prop function. By controlling a player-controlled virtual object to interact with a resource redemption point to obtain a prop-holding reward, the appeal of a game is improved, gameplay is enriched, and human-computer interaction efficiency is enhanced. An application scenario of the reward obtaining method provided in the examples of this application includes at least one of a plurality of virtual scenes such as a virtual shooting scene and a virtual match scene. The foregoing application scenarios are merely exemplary, and the reward obtaining method provided in the examples may be further applied to other scenarios. This is not limited in the examples of this application.

In this application, a prompt interface or a pop-up window may be displayed, or voice prompt information may be outputted before and during collection of relevant data of a user. The prompt interface, the pop-up window, or the voice prompt information is configured for prompting the user that the relevant data of the user is currently being collected. In this application, only after a confirmation operation performed by the user for the prompt interface or the pop-up window is obtained, the relevant operation of obtaining the relevant data of the user is performed. Otherwise, that is, when the confirmation operation performed by the user for the prompt interface or the pop-up window is not obtained, the relevant operation of obtaining the relevant data of the user is terminated, that is, the relevant data of the user is not obtained. In other words, in this application, all collected user data is collected with user consent and authorization, and collection, use, and processing of the relevant user data need to comply with relevant laws, regulations, and standards of relevant countries and regions.

A terminal in the examples of this application may be a desktop computer, a portable laptop computer, a mobile phone, a tablet computer, an e-book reader, a moving picture experts group audio layer III (MP3) player, a moving picture experts group audio layer IV (MP4) player, or the like. An application program supporting a virtual environment, for example, an application program supporting a three-dimensional virtual environment, is deployed and run on the terminal. The application program may be any one of a virtual reality application program, a three-dimensional map program, a third-person shooting (TPS) game, a first-person shooting (FPS) game, and a multiplayer online battle arena (MOBA) game. In an example, the application program may be a standalone application program, such as a standalone three-dimensional game application, or may be an online application program.

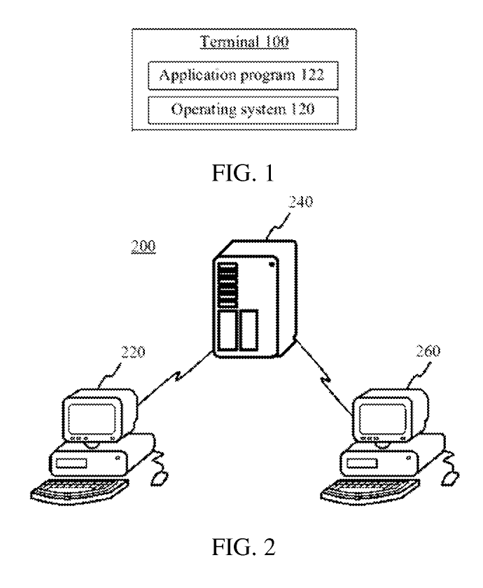

FIG. 1 is a structural block diagram of an electronic device according to an exemplary example of this application. An electronic device 100 includes: an operating system 120 and an application program 122.

The operating system 120 is basic software that provides the application program 122 with secure access to computer hardware. The application program 122 is an application supporting a virtual environment. In an example, the application program 122 is an application supporting a three-dimensional virtual environment. The application program 122 may be any one of a virtual reality application program, a three-dimensional map program, a TPS game, an FPS game, a MOBA game, and a multiplayer shooter survival game. The application program 122 may be a standalone application program, such as a standalone three-dimensional game application, or may be an online application program.

FIG. 2 is a structural block diagram of a computer system according to an exemplary example of this application. A computer system 200 includes: a first device 220, a server 240, and a second device 260.

An application program supporting a virtual environment is deployed and run on the first device 220. The application program may be any one of a virtual reality application program, a three-dimensional map program, a TPS game, an FPS game, a MOBA game, and a multiplayer shooter survival game. The first device 220 is a device used by a first user. The first user uses the first device 220 to control a first virtual object in a virtual environment to perform an activity. The activity includes, but is not limited to, at least one of body posture adjustment, crawling, walking, running, riding, jumping, driving, picking up, shooting, attacking, and throwing. For example, the first virtual object is a first virtual person, such as a simulated person character or an animated person character.

The first device 220 is connected to the server 240 via a wireless network or a wired network.

The server 240 includes at least one of a single server, a plurality of servers, a cloud computing platform, and a virtualization center. The server 240 is configured to provide a backend service for the application program supporting the three-dimensional virtual environment. In an example, the server 240 is responsible for main computational tasks, and the first device 220 and the second device 260 are responsible for less critical computational tasks. Alternatively, the server 240 is responsible for less critical computational tasks, and the first device 220 and the second device 260 are responsible for primary computational tasks. Alternatively, the server 240, the first device 220, and the second device 260 perform collaborative computing by using a distributed computing architecture.

An application program supporting a virtual environment is deployed and run on the second device 260. The application program may be any one of a virtual reality application program, a three-dimensional map program, an FPS game, a MOBA game, and a multiplayer shooter survival game. The second device 260 is a device used by a second user. The second user uses the second device 260 to control a second virtual object in a virtual environment to perform an activity. The activity includes, but is not limited to, at least one of body posture adjustment, crawling, walking, running, riding, jumping, driving, picking up, shooting, attacking, and throwing. For example, the second virtual object is a second virtual person, such as a simulated person character or an animated person character.

In an example, the first virtual object and the second virtual object are in a same virtual environment. In an example, the first virtual object and the second virtual object may belong to a same team or a same organization, or have a friend relationship, or have a temporary communication permission. In an example, the first virtual object and the second virtual object may alternatively belong to different teams, different organizations, or two adversarial groups.

In an example, the application programs deployed on the first device 220 and the second device 260 are the same, or the application programs deployed on the two devices are application programs of a same type on different operating system platforms. The first device 220 may generically refer to one of a plurality of devices, and the second device 260 may generically refer to one of a plurality of devices. This example is described only by using the first device 220 and the second device 260 as an example. The first device 220 and the second device 260 may be terminals of a same device type or of different device types. The device type includes: at least one of a game console, a desktop computer, a smartphone, a tablet computer, an e-book reader, an MP3 player, an MP4 player, and a laptop portable computer.

A person skilled in the art may learn that more or fewer first devices 220 and second devices 260 may exist. For example, only one first device 220 and only one second device 260 exist, or dozens or hundreds of first devices 220 and dozens or hundreds of second devices 260 may exist, or more first devices and more second devices may exist. A quantity of first devices 220 and a quantity of second devices 260, as well as a device type of the first device and a device type of the second device are not limited in the examples of this application.

The server 240 may be implemented as a physical server or a cloud server in the cloud. The cloud technology refers to a hosting technology that unifies a series of resources such as hardware, software, and networks in a wide area network or a local area network to implement computing, storage, processing, and sharing of data. The cloud technology is a general term for network technology, information technology, integration technology, management platform technology, and application technology that are applied based on a cloud computing business model, can form a resource pool, and can be used on demand, which is flexible and convenient.

In some examples, the method provided in the examples of this application may be applied to a cloud gaming scenario. In this case, calculation of data logic in a game process is completed through a cloud server, and a terminal is responsible for displaying a game interface.

In some examples, the server 240 may alternatively be implemented as a node in a blockchain system.

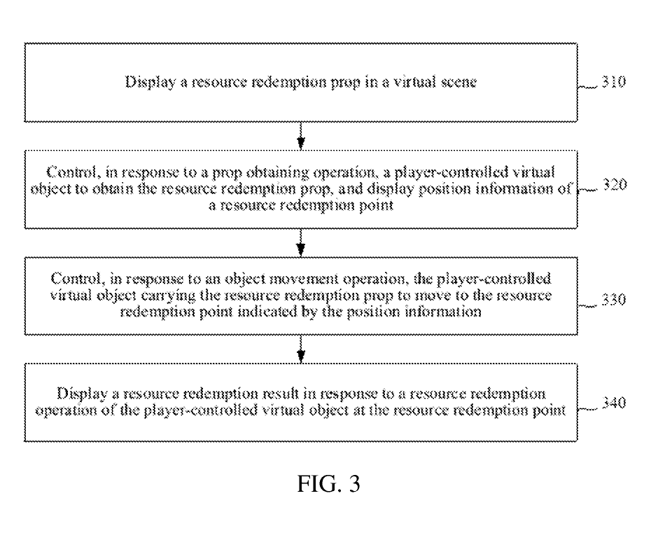

The reward obtaining method provided in the examples of this application is described with reference to the foregoing brief introduction and application scenarios of the terms. A description is made by using an example in which the method is applied to a computer device and the computer device may be a terminal. A player-controlled account of a player-controlled virtual object is logged into on the terminal. As shown in FIG. 3, the method includes operation 310 to operation 340.

Operation 310: Display a resource redemption prop in a virtual scene.

For example, the virtual scene refers to a scene image displayed by the terminal based on a game process, and the virtual scene may be any one of a plurality of scenes built in a game.

In an example, the virtual scene includes at least one virtual object. The virtual object is configured for representing an object participating in a virtual match. The virtual scene is a scene of the virtual match, and is provided for the virtual object to complete various game tasks in a virtual match process.

In an example, the virtual scene further includes at least one virtual prop. The virtual prop includes at least one of a plurality of props such as a virtual attack prop, a resource redemption prop, a virtual treatment item, and a virtual defense item. For example, by controlling the virtual object, the virtual object performs various prop operations such as picking up a virtual prop, using a virtual prop, and trading a virtual prop in a virtual scene. The resource redemption prop is configured for obtaining a prop-holding reward after redemption. For example, the prop-holding reward includes at least one of the following forms: (1) obtaining a virtual resource, for example, obtaining a virtual resource that can be redeemed for content such as another virtual prop, virtual equipment, or a virtual skin; (2) obtaining a match extraction reward, for example, the virtual match requires extraction from a specified point, and when the prop-holding reward is obtained based on the resource redemption prop, the virtual battle can be successfully evacuated from any position point on a virtual map; and (3) obtaining a rare virtual skin; and (4) doubling at least one of a quantity of picked virtual props and an attribute value, and the like.

The virtual scene further includes the player-controlled virtual object and an opponent virtual object. The player-controlled virtual object refers to a virtual object controlled by the player-controlled account. One player-controlled virtual object may exist, and one or more opponent virtual objects may exist.

For example, the virtual scene includes a plurality of virtual objects. The plurality of virtual objects include the player-controlled virtual object. The player-controlled virtual object refers to a virtual object controlled by a player who controls the current terminal to perform a game process. In addition, the plurality of virtual objects further include the opponent virtual object The opponent virtual object and the player-controlled virtual object belong to different virtual factions.

In an example, the plurality of virtual objects further include a teammate virtual object. The teammate virtual object refers to a virtual object belonging to a same virtual faction as the player-controlled virtual object. One or more teammate virtual objects may exist.

Operation 320: Control, in response to a prop obtaining operation, a player-controlled virtual object to obtain the resource redemption prop, and display position information of a resource redemption point.

The prop obtaining operation is configured for controlling the player-controlled virtual object to obtain the resource redemption prop. The prop obtaining operation includes at least one of the following: a prop picking operation for picking up a resource redemption prop, and performing a specified task to obtain the resource redemption prop.

In an example, the resource redemption prop randomly occurs at any position point on the virtual map. The position point may be a fixed position point, or may be a non-fixed position point. The prop obtaining operation is implemented as a prop picking operation. When the player-controlled virtual object is controlled to move to the position point and perform the prop picking operation, the prop obtaining operation for the resource redemption prop is performed.

In an example, at a position point of the resource redemption prop, the resource redemption prop may be guarded by a plurality of non-player characters (NPC), and the specified task includes defeating the plurality of NPCs. The player-controlled virtual object is controlled to move to the position point and defeat other NPCs, which means that the prop obtaining operation is performed for the resource redemption prop.

In some examples, after the player-controlled virtual object obtains the resource redemption prop based on the prop obtaining operation, the position information of the resource redemption point may be displayed on an interface. The resource redemption point is configured for prompting the player-controlled virtual object that reward redemption can be performed based on the resource redemption prop, to obtain the prop-holding reward. For example, the resource redemption point may be configured for assisting the player-controlled virtual object in obtaining the prop-holding reward through the resource redemption prop.

The position information of the resource redemption point is configured for representing the position of the resource redemption point in the virtual scene. The resource redemption point may randomly occur at any position point on the virtual map. The position point may be a fixed position point, or may be a non-fixed position point. Alternatively, the position point of the resource redemption point may correspond to the resource redemption prop. In an example, the position information is implemented as a coordinate position of the resource redemption point. Alternatively, the position information is implemented as a position identifier of the resource redemption point on the virtual map. The position identifier includes at least one of the following: a graphic element, text, an icon, a control, and a button.

After the resource redemption prop is obtained by the player-controlled virtual object, prompt information is displayed from the perspective of the opponent virtual object. The prompt information includes a prop identifier corresponding to the resource redemption prop, and the prompt information is configured for prompting the opponent virtual object to contend for ownership of the resource redemption prop. When the player-controlled virtual object possesses the ownership of the resource redemption prop, the player-controlled virtual object can obtain the prop-holding reward after redemption. When the opponent virtual object possess the ownership of the resource redemption prop, the opponent virtual object can obtain the prop-holding reward after redemption.

In an example, when the resource redemption prop exists in the plurality of virtual props, the position of the resource redemption prop may be represented by the prop identifier. The prop identifier is configured for uniquely representing the resource redemption prop. In an example, the prop identifier includes at least one of the following: a graphic element, text, an icon, a control, and a button. After the resource redemption prop is obtained by the player-controlled virtual object, an indication function of the prop identifier does not disappear, and the prop identifier moves based on the possession of the resource redemption prop by the player-controlled virtual object and indicates a position change situation of the player-controlled virtual object.

In some examples, the prompt information further indicates a real-time prop position of the resource redemption prop, and further indicates position information of the player-controlled virtual object carrying the resource redemption prop. To be specific, the prompt information is configured for prompting the prop position of the resource redemption prop in real time, and the prop position is continuously exposed until a virtual object of a party obtains the prop-holding reward. That is, the position of the player-controlled virtual object is exposed and displayed based on the prop identifier of the resource redemption prop.

For example, the prompt information is displayed on a terminal interface corresponding to the opponent virtual object. The prompt information can prompt the opponent virtual object of a position of the player-controlled virtual object carrying the resource redemption prop at a current moment. In this case, the opponent virtual object learns the position of the player-controlled virtual object, and competes with the player-controlled virtual object for the ownership of the resource redemption prop.

In some examples, the resource redemption prop may further be understood as a bidirectional interactive positioning prop, or understood as a virtual prop having a bidirectional interactive positioning function. After the resource redemption prop is obtained, bidirectional interactive positioning is triggered. In this case, both the player-controlled virtual object and the opponent virtual objects can view the prop position in real time, and a position of a virtual object currently possessing the ownership of the resource redemption prop is exposed.

In an example, the opponent virtual object is configured for competing for the ownership of the resource redemption prop based on the prompt information, and the opponent virtual object snatches the resource redemption prop from the player-controlled virtual object. For example, after eliminating the player-controlled virtual object, the opponent virtual objects obtain the resource redemption prop. Alternatively, after inflicting a preset amount of damage on the player-controlled virtual object, the opponent virtual object obtains the resource redemption prop, or the like.

Operation 330: Control, in response to an object movement operation, the player-controlled virtual object carrying the resource redemption prop to move to the resource redemption point indicated by the position information.

For example, in a process in which the player-controlled virtual object carries the resource redemption prop, the player can control the player-controlled virtual object to move toward the resource redemption point. This operation is regarded as the object movement operation. In response to the object movement operation, the player-controlled virtual object carrying the resource redemption prop moves to the resource redemption point indicated by the position information.

Operation 340: Display a resource redemption result in response to a resource redemption operation performed by the player-controlled virtual object at the resource redemption point.

For example, the resource redemption operation refers to an operation of performing redemption through the resource redemption prop at the resource redemption point, to obtain the prop-holding reward after the redemption. In an example, the resource redemption operation is configured for describing content of controlling the player-controlled virtual object to perform a specified interaction operation with the resource redemption point. For example, the player-controlled virtual object is controlled to stay at the resource redemption point for fixed preset duration, and the process is regarded as the resource redemption operation. Alternatively, the player-controlled virtual object is controlled to interact with a preset control at the resource redemption point, and the interaction process is regarded as the resource redemption operation, or the like. In an example, the preset duration may be set according to an actual technical requirement, and may be at least one of the following: setting to a fixed value, random setting, and setting based on at least one of redemption difficulty, a weight, and an attribute value of the resource redemption point.

In an example, after the player-controlled virtual object is controlled to perform the resource redemption operation, the resource redemption result may be displayed. The resource redemption result is configured for indicating reward information obtained by the player-controlled virtual object by redeeming the resource redemption prop. For example, the reward information is configured for representing an obtaining situation of the prop-holding reward corresponding to the resource redemption prop, that is, the resource redemption result is a situation of the prop-holding reward obtained by the player-controlled virtual object. For example, the resource redemption result represents that the player-controlled virtual object obtains all prop-holding rewards. Alternatively, the resource redemption result represents that the player-controlled virtual object does not obtain the prop-holding reward. Alternatively, the resource redemption result represents that the player-controlled virtual object obtains some prop-holding rewards, or the like.

The foregoing is merely exemplary. This is not limited in the examples of this application.

In conclusion, the resource redemption prop configured for redeeming for the prop-holding reward is displayed in the virtual scene, the player-controlled virtual object is controlled to obtain the resource redemption prop after the prop obtaining operation is received, and the position information of the resource redemption point is displayed. After the resource redemption prop is obtained, the prompt information is displayed from the perspective of the opponent virtual object, to prompt the opponent virtual object to contend for the ownership of the resource redemption prop. Then, in response to the object movement operation, the player-controlled virtual object carrying the resource redemption prop is controlled to move to the resource redemption point, and the resource redemption result is displayed after the resource redemption point receives the resource redemption operation. The resource redemption prop is endowed with a new prop function. When the player-controlled virtual object possesses the ownership of the resource redemption prop, by controlling the player-controlled virtual object to interact with the resource redemption point, the prop-holding reward corresponding to the resource redemption prop may be directly obtained in a virtual match. Compared with the related art in which the prop-holding reward can only be obtained after extraction from or completion of the virtual match, this application can improve efficiency of obtaining the prop-holding reward, and improve human-computer interaction efficiency. In addition, in the process, the prompt information is displayed from the perspective of the opponent virtual object, whereby information accessibility is improved. Furthermore, in the process, the opponent virtual objects may contend with the player-controlled virtual object for the ownership of the resource redemption prop, whereby difficulty in obtaining the prop-holding reward can be adjusted, the appeal of a game is improved, and gameplay is enriched. This facilitates efficient progress of a virtual match between different players, and further improves human-computer interaction efficiency.

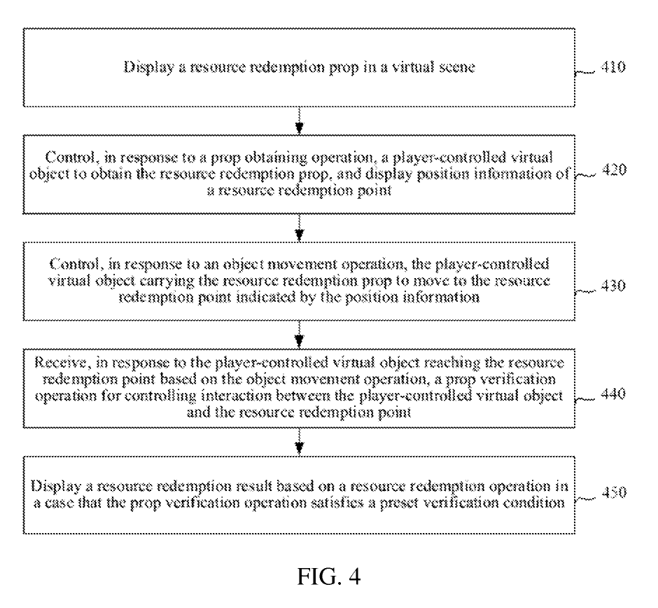

In an example, after the player-controlled virtual object moves to the resource redemption point based on the object movement operation, the player-controlled virtual object may be controlled to interact with the resource redemption point, to implement the resource redemption operation. For example, as shown in FIG. 4, the example shown in FIG. 3 may further be implemented as operation 410 to operation 450; and operation 340 shown in FIG. 3 may further be implemented as operation 440 to operation 450.

Operation 410: Display a resource redemption prop in a virtual scene.

The resource redemption prop is configured for redeem for a prop-holding reward. The virtual scene further includes a player-controlled virtual object and an opponent virtual object. The player-controlled virtual object refers to a virtual object controlled by a player-controlled account.

In some examples, the resource redemption prop is implemented as a prop that occurs with a particular probability in a virtual match. To be specific, in one virtual match, the resource redemption prop may occur or may not occur. For example, if a preset prop occurrence probability is 0.6, in one virtual match, the resource redemption prop may occur in a virtual scene corresponding to the virtual match with a probability of 60%, and a resource redemption prop may not occur in the virtual scene corresponding to the virtual match with a probability of 40%.

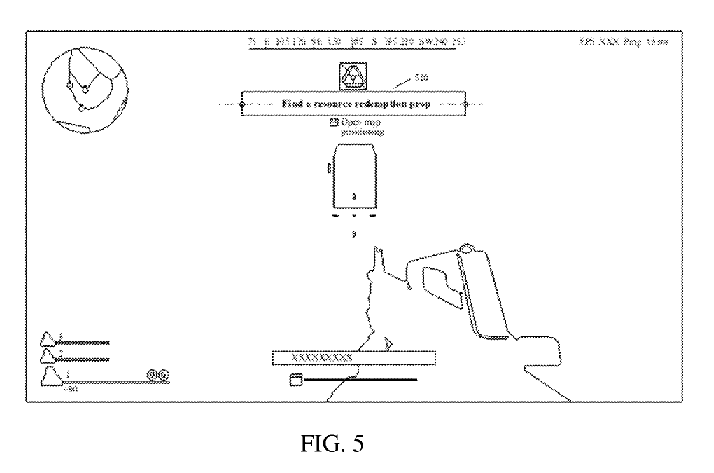

For example, when the resource redemption prop occurs in the virtual scene, prop occurrence prompt information is displayed, to notify an occurrence situation of the resource redemption prop. For example, the prop occurrence prompt information is "Find a resource redemption prop". FIG. 5 is a schematic diagram of an interface showing prop occurrence prompt information. In a virtual match process, after the resource redemption prop that occurs with a particular probability occurs in the virtual scene, prop occurrence prompt information 510 of "Find a resource redemption prop" is displayed, to notify the player-controlled virtual object that the resource redemption prop is found.

In an example, the prop occurrence prompt information 510 shown in FIG. 5 may be displayed on terminal interfaces respectively corresponding to a plurality of virtual objects participating in the virtual match. This is not limited herein. The plurality of virtual objects participating in the virtual match may be all or some of all virtual objects participating in the match.

In some examples, the plurality of virtual objects participating in the virtual match may respectively view a prop position of the resource redemption prop may be viewed through a virtual map corresponding to the virtual match. The virtual map is configured for viewing an entire terrain of the virtual match.

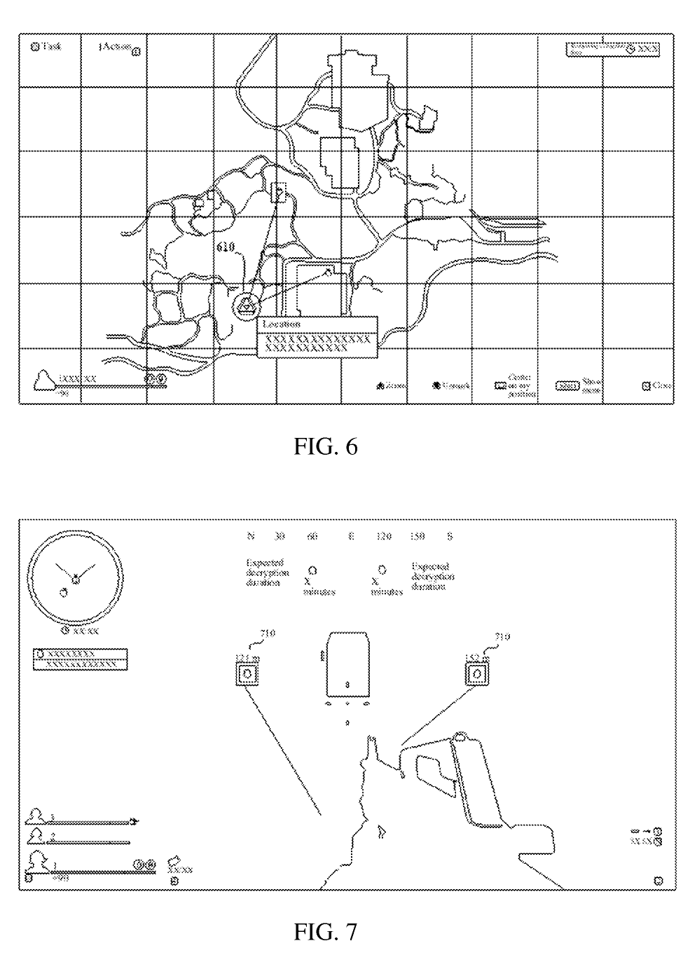

FIG. 6 is a schematic diagram of a prop position of a resource redemption prop on a virtual map. The prop position is presented by a prop identifier 610. Position information of the resource redemption prop in the virtual match may be determined by comparing a position of the prop identifier 610 with another geographic position on the virtual map.

In some examples, at least one resource redemption prop occurs in the virtual scene. In an example, in the virtual scene corresponding to the virtual match, a single resource redemption prop may occur, or a plurality of virtual redemption props may occur. In an example, in the virtual scene corresponding to the virtual match, no resource redemption prop may occur probabilistically, a single resource redemption prop may occur, a plurality of virtual redemption props may occur, or the like.

Operation 420: Control, in response to a prop obtaining operation, a player-controlled virtual object to obtain the resource redemption prop, and display position information of a resource redemption point.

The prop obtaining operation is configured for controlling the player-controlled virtual object to obtain the resource redemption prop. The resource redemption point is configured for prompting the player-controlled virtual object that reward redemption can be performed based on the resource redemption prop, to obtain the prop-holding reward. After the resource redemption prop is obtained by the player-controlled virtual object, prompt information is displayed from the perspective of the opponent virtual object. The prompt information includes a prop identifier corresponding to the resource redemption prop, and the prompt information is configured for prompting the opponent virtual object to contend for ownership of the resource redemption prop.

In an example, after the player-controlled virtual object possesses the resource redemption prop, a task target is automatically triggered. In this case, the player-controlled virtual object carries the resource redemption prop to the resource redemption point to perform resource redemption.

In an example, position information of at least one resource redemption point is displayed. The position information may be implemented as information for describing a distance and a direction of the player-controlled virtual object relative to the resource redemption point, or may be implemented as information for describing position coordinates of the resource redemption point, or the like.

For example, the virtual scene corresponding to the virtual match may include one resource redemption point, or may include at least two resource redemption points. When at least two resource redemption points are included, the at least two resource redemption points may support a same resource redemption function, and resource redemption may be performed at any resource redemption point.

As shown in FIG. 7, an example in which the position information is implemented as information for describing a distance and a direction of the player-controlled virtual object relative to the resource redemption point is used. When the player-controlled virtual object possesses the resource redemption prop, two resource redemption points 710 are displayed. Each resource redemption point deviates from the player-controlled virtual object in a direction. That is, the position information represents direction information of each resource redemption point. Each resource redemption point is further marked with a distance (such as 211 meters). That is, the position information further represents distance information of each resource redemption point. Position information of the two resource redemption points 710 may be determined by combining the direction information and the distance information.

In some examples, the resource redemption prop occurs on a preset prop storage rack in the virtual scene. In a process in which the player-controlled virtual object retrieves the resource redemption prop from the preset prop storage rack, it may be set by default that the player-controlled virtual object has a prop retrieval silence time period. The prop retrieval silence time period is configured for limiting an object operation of the player-controlled virtual object. For example, within the prop retrieval silence time period, the player-controlled virtual object cannot perform a prop attack operation. Alternatively, within the prop retrieval silence time period, the player-controlled virtual object cannot perform a dodge operation, or the like.

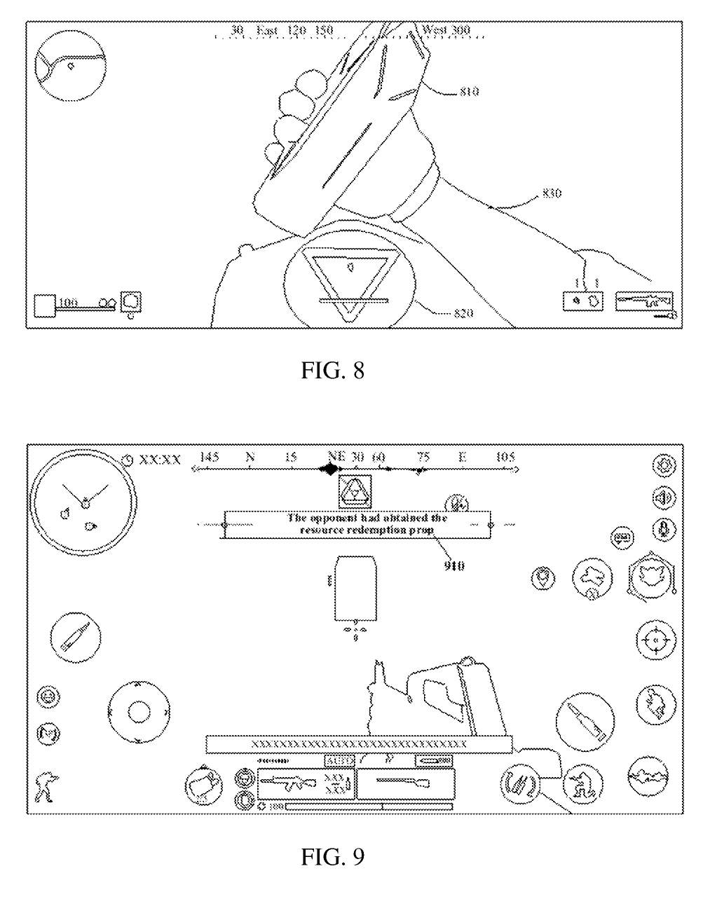

FIG. 8 is a schematic diagram of obtaining a resource redemption prop by a player-controlled virtual object. A resource redemption prop 810 is located on a preset prop storage rack 820. In a process in which a player-controlled virtual object 830 retrieves the resource redemption prop 810 from the preset prop storage rack 820, some object operations of the player-controlled virtual object 830 are limited within a prop retrieval silence time period. In an example, the resource redemption prop 810 may alternatively be displayed in a highlighted manner in a retrieval process.

Through the prop retrieval silence time period, visual presentation may be enhanced. In addition, the opponent virtual object is allowed to defeat the player-controlled virtual object in a manner such as an ambush attack, which enriches gameplay and improves the appeal of a game.

In some examples, after the player-controlled virtual object obtains the resource redemption prop, prop obtaining prompt information may be displayed on terminal interfaces respectively corresponding to a plurality of virtual objects participating in the match. The prop obtaining prompt information is configured for prompting the ownership of the resource redemption prop, that is, currently, a virtual object obtains the resource redemption prop.

In an example, the prop obtaining prompt information represents that a virtual object obtains the resource redemption prop, but does not display an object identifier of the virtual object, such as an object nickname or an object avatar. Alternatively, the prop obtaining prompt information directly displays an object identifier of the virtual object, such as an object nickname or an object avatar. This is not limited herein.

For example, when the player-controlled virtual object obtains the resource redemption prop, in prop obtaining prompt information displayed on a terminal interface of a teammate virtual object belonging to a same virtual faction as the player-controlled virtual object, it is prompted that: "Our side has obtained the resource redemption prop"; or "Our teammate X has obtained the resource redemption prop", or the like.

When the player-controlled virtual object obtains the resource redemption prop, in prop obtaining prompt information displayed on a terminal interface of the opponent virtual object belonging to a faction different from that of the player-controlled virtual object, it is prompted that: "The opponent has obtained the resource redemption prop". For example, as shown in FIG. 9, in prop obtaining prompt information 910 displayed on a terminal interface of an opponent virtual object belonging to a virtual faction different from that of the player-controlled virtual object, it is prompted that: "The opponent has obtained the resource redemption prop".

In an example, in addition to displaying the position information of the resource redemption point on the terminal interface of the player-controlled virtual object, the position information of the resource redemption point may further be displayed on the virtual map. In this way, another virtual object may also learn a position of the resource redemption point. In an example, the another virtual object includes at least one of the following: a teammate virtual object and an opponent virtual object.

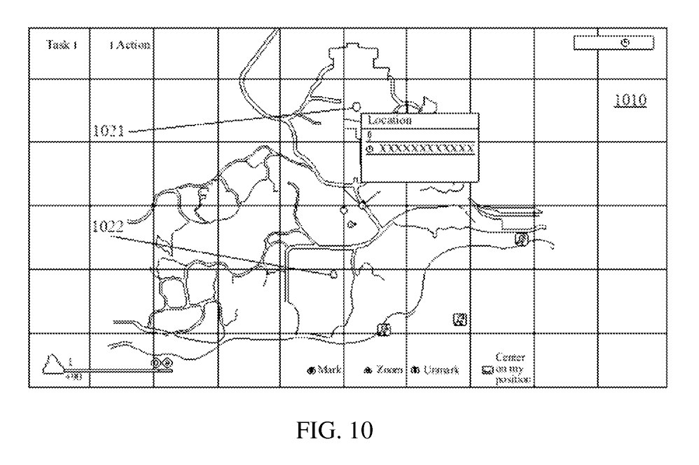

For example, FIG. 10 is a schematic diagram of displaying position information of a resource redemption point on a virtual map. A virtual map 1010 includes two resource redemption points, which are a resource redemption point 1021 and a resource redemption point 1022, respectively.

The foregoing is merely exemplary. This is not limited in the examples of this application.

Operation 430: Control, in response to an object movement operation, the player-controlled virtual object carrying the resource redemption prop to move to the resource redemption point indicated by the position information.

For example, in a process in which the player-controlled virtual object carries the resource redemption prop, the player can control the player-controlled virtual object to move toward the resource redemption point. This operation is regarded as the object movement operation.

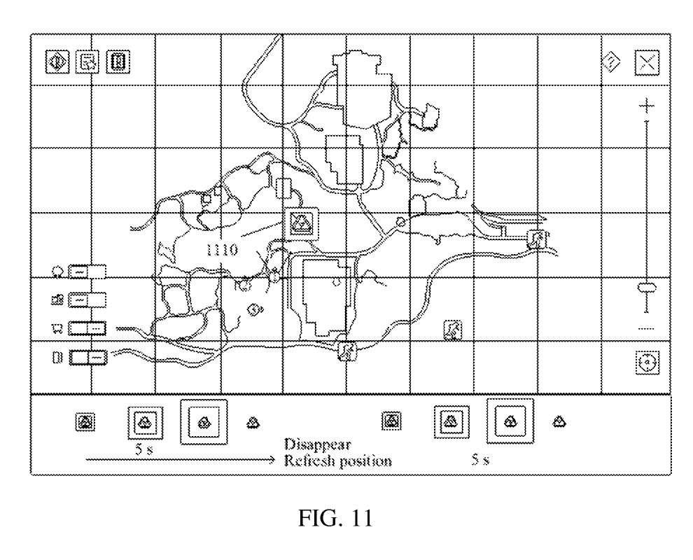

In some examples, the resource redemption prop includes a prop identifier. The prop identifier reveals a position of the resource redemption prop. Therefore, a position of the player-controlled virtual object who moves while carrying the resource redemption prop is also exposed based on the prop identifier. For example, FIG. 11 is a schematic diagram of an interface showing that an opponent virtual object determines a player-controlled virtual object based on a prop identifier 1110 displayed on a terminal interface of the opponent virtual object. Therefore, the opponent virtual object may roughly determine a position of the player-controlled virtual object based on the prop identifier 1110.

In an example, because the position of the player-controlled virtual object is exposed based on the prop identifier and a position of the teammate virtual object is not exposed, the player-controlled virtual object may further abandon the resource redemption prop at a position point, and the player-controlled virtual object and the teammate virtual object are allowed to ambush the opponent virtual object near the position point. By sharing the position information of the resource redemption prop, a game match is performed based on asymmetric information. This enriches gameplay and improves the appeal of a game.

Operation 440: Receive, in response to the player-controlled virtual object reaching the resource redemption point based on the object movement operation, a prop verification operation for controlling interaction between the player-controlled virtual object and the resource redemption point.

The prop verification operation is configured for verifying the resource redemption prop. For example, whether the resource redemption prop is correct may be determined through the prop verification operation. Alternatively, the prop verification operation may be considered as an operation verification process indicating correct interaction between the player-controlled virtual object and the resource redemption point.

In an example, a prop verification container exists at the resource redemption point, and an operation of interacting between the player-controlled virtual object and the prop verification container is used as the prop verification operation. For example, an operation of controlling the player-controlled virtual object to insert the resource redemption prop into the prop verification container is used as the prop verification operation. Alternatively, an operation of controlling the player-controlled virtual object carrying the resource redemption prop to touch the prop verification container is used as the prop verification operation.

Operation 450: Display a resource redemption result based on a resource redemption operation in a case that the prop verification operation satisfies a preset verification condition.

In an example, the resource redemption operation is an operation manually triggered, for example, manually implemented based on the player. Alternatively, the resource redemption operation is implemented as an automatically triggered operation. For example, the resource redemption operation is automatically triggered when a preset condition is satisfied.

For example, the preset verification condition is a verification condition that is set in advance, and the verification condition is implemented as at least one of a plurality of conditions such as a time condition and a defense condition. In an example, the time condition is that: for example, the player-controlled virtual object survives within a preset time period; or both the player-controlled virtual object and the teammate virtual object survive within the preset time period; or the teammate virtual objects all survive within the preset time period. In an example, the defense condition is that: for example, the player-controlled virtual object is not attacked by the opponent virtual object.

In an example, in response to absence of interference from the opponent virtual object within verification duration corresponding to the prop verification operation, the resource redemption result is displayed based on the resource redemption operation. When the opponent virtual object does not possess the ownership of the resource redemption prop within the verification duration, it is considered that the player-controlled virtual object is not subjected to interference from the opponent virtual object. That is, in response to the opponent virtual object failing to possess the ownership of the resource redemption prop within the verification duration corresponding to the prop verification operation, the resource redemption result is displayed based on the resource redemption operation.

For example, the player-controlled virtual object is controlled to successfully insert the resource redemption prop into the prop verification container, and a successful insertion process is considered as the prop verification operation of an interaction operation. For example, a process in which the player-controlled virtual object is controlled to insert the resource redemption prop into the prop verification container and the player-controlled virtual object long presses an interaction control for the verification duration is considered as the successful insertion process. The verification duration refers to duration such as 3 s or 5 s.

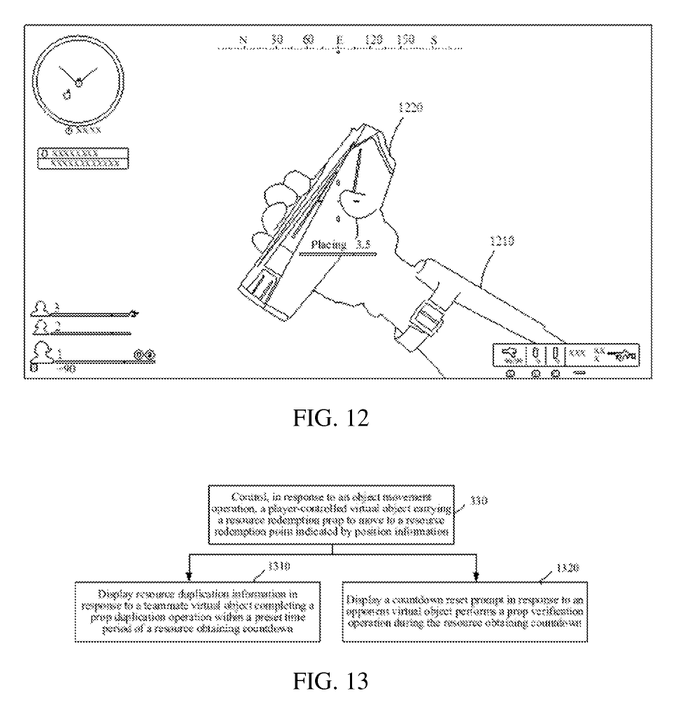

FIG. 12 is a schematic diagram of an interface showing that a player-controlled virtual object is controlled to interact with a prop verification container. A process in which a player-controlled virtual object 1210 inserts a resource redemption prop 1220 into a prop verification container and the player-controlled virtual object long presses an interaction control for 5 s is considered as a successful insertion process, that is, considered as performing the prop verification operation.

That is, if the player-controlled virtual object maintains a fixed interaction process with the prop verification container within the verification duration and is not subjected to interference from the opponent virtual object, the player-controlled virtual object may continue to perform the resource redemption operation at the resource redemption point.

In some examples, an object operation of the player-controlled virtual object is limited within the verification duration, for example, prohibited from attacking the opponent virtual object or moving. In this case, the teammate virtual object need to protect the player-controlled virtual object from interference from the opponent virtual object. By utilizing operational restrictions and coordination of the teammate virtual object, gameplay can be enriched to avoid monotony in a game.

In an example, a resource obtaining countdown is displayed in a case that the prop verification operation satisfies the preset verification condition. The player-controlled virtual object and the teammate virtual objects need to successfully protect the resource redemption prop during the resource obtaining countdown. The teammate virtual object refers to a virtual object belonging to a same faction as the player-controlled virtual object. If the player-controlled virtual object continuously possesses the ownership of the resource redemption prop during the resource obtaining countdown, it is considered that the resource redemption prop is successfully protected. That is, the resource redemption result is displayed in response to the player-controlled virtual object possessing the ownership of the resource redemption prop during the resource obtaining countdown.

For example, in a case that the prop verification operation satisfies the preset verification condition, the resource obtaining countdown is displayed on an interface. The resource obtaining countdown is configured for representing a countdown for automatically triggering the resource redemption operation.

In an example, the resource obtaining countdown is configure for measuring duration with which the player-controlled virtual object can obtain the prop-holding reward. After the resource obtaining countdown ends, the player-controlled virtual object may obtain the prop-holding reward based on the resource redemption prop, that is, it is considered that the resource redemption operation is automatically triggered.

For example, the resource obtaining countdown is a countdown that is set in advance, such as 5 minutes or 3 minutes. Alternatively, the resource obtaining countdown is a countdown generated based on a situation of the virtual match. For example, when more than 50 virtual objects exist in the virtual match, the resource obtaining countdown is 3 minutes; when more than 30 virtual objects exist in the virtual match, the resource obtaining countdown is 5 minutes; or when more than 20 virtual objects exist in the virtual match, the resource obtaining countdown is 7 minutes. Alternatively, the resource obtaining countdown is a countdown determined based on match performance of the player-controlled virtual object in the virtual match. For example, if the player-controlled virtual object defeats three virtual objects, the resource obtaining countdown is 5 minutes; or if the player-controlled virtual object defeats five virtual objects, the resource obtaining countdown is 6 minutes. Alternatively, the resource obtaining countdown corresponds to the resource redemption prop. Alternatively, the resource obtaining countdown is randomly set. Alternatively, the resource obtaining countdown is set based on at least one of redemption difficulty, a weight, and an attribute value of the resource redemption point. That is, selection of the resource obtaining countdown is flexible. This is not limited herein.

In an example, the resource redemption result is displayed in response to the player-controlled virtual object possessing the ownership of the resource redemption prop during the resource obtaining countdown, that is, the player-controlled virtual object and the teammate virtual object successfully protecting the resource redemption prop from being snatched by the opponent virtual object. The resource redemption result may be represented by resource redemption information. The resource redemption information is information generated based on the automatically triggered resource redemption operation. The resource redemption information is configured for prompting the player-controlled virtual object to obtain the prop-holding reward by redeeming the resource redemption prop.

For example, if the player-controlled virtual object possesses the ownership of the resource redemption prop during the resource obtaining countdown, the resource redemption result is displayed. Alternatively, if the player-controlled virtual object and the teammate virtual object possess the ownership of the resource redemption prop during the resource obtaining countdown, the resource redemption result is displayed.

For example, if the ownership of the resource redemption prop is possessed during the resource obtaining countdown, that is, the resource redemption prop is successfully protected from being snatched by the opponent virtual object, in other words, the opponent virtual object fails to snatch the resource redemption prop, the resource redemption operation is automatically triggered. In this case, an obtaining situation of the prop-holding reward obtained through the resource redemption prop is displayed, that is, resource redemption is displayed.

In an example, a resource obtaining control is displayed in response to the player-controlled virtual object possessing the ownership of the resource redemption prop during the resource obtaining countdown, that is, the player-controlled virtual object and the teammate virtual object successfully protecting the resource redemption prop from being snatched by the opponent virtual object. The resource obtaining control is configured to prompt the player-controlled virtual object to obtain the prop-holding reward by redeeming the resource redemption prop.

For example, if the resource redemption prop is successfully protected from being snatched by the opponent virtual object during the resource obtaining countdown, that is, the opponent virtual object fails to snatch the resource redemption prop, the resource obtaining control may be displayed on a terminal interface corresponding to the player-controlled virtual object, to remind the player-controlled virtual object that the prop-holding reward can be obtained by triggering the resource obtaining control.

In an example, the resource redemption result is displayed based on a trigger operation for the resource obtaining control that is regarded as the resource redemption operation.

The foregoing is merely exemplary. This is not limited in the examples of this application.

In conclusion, the resource redemption prop is endowed with a new prop function. When the player-controlled virtual object possesses the ownership of the resource redemption prop, the prop-holding reward corresponding to the resource redemption prop is obtained by controlling the player-controlled virtual object to interact with the resource redemption point. This enriches reward obtaining manners. In this process, the opponent virtual object may further contend with the player-controlled virtual object for the ownership of the resource redemption prop, whereby difficulty in obtaining the prop-holding reward is adjusted, the appeal of a game is improved, and gameplay is enriched. This facilitates efficient progress of a virtual match between different players, and improves human-computer interaction efficiency.

In the examples of this application, content of controlling the player-controlled virtual object to interact with the resource redemption point to implement the resource redemption operation is described. A process of verifying the resource redemption prop is implemented through a process of controlling the player-controlled virtual object to interact with the prop verification container at the resource redemption point. Further, in a case that the preset verification condition is satisfied, redemption for the prop-holding reward can be successfully performed through the resource redemption operation during the resource obtaining countdown. Alternatively, the prop-holding reward is snatched by another opponent virtual object. A condition for protecting the resource redemption prop quantified through the resource obtaining countdown, whereby gameplay is enriched, the appeal of a game is improved, and efficiency of interaction between a plurality of players is improved.

In an example, the player-controlled virtual object and the teammate virtual object belong to a same faction, and the player-controlled virtual object and the teammate virtual object belong to a faction different from that of the opponent virtual object. After the player-controlled virtual object obtains the prop-holding reward after successfully interacting with the resource redemption point, the teammate virtual object may also obtain the prop-holding reward based on interaction with the resource redemption point. In addition, the opponent virtual object may also snatch the resource redemption prop before the player-controlled virtual object successfully interacts with the resource redemption point. For example, as shown in FIG. 13, after operation 330 shown in FIG. 3, operation 1310 or operation 1320 may be further included.

Operation 1310: Display resource duplication information in response to a teammate virtual object completing a prop duplication operation within a preset time period of a resource obtaining countdown.

The prop duplication operation is configured for representing an interaction process performed between the teammate virtual object and the resource redemption point.

For example, the preset time period refers to a partial time period of the resource obtaining countdown. For example, the resource obtaining countdown is 5 minutes, and the preset time period is the last one minute. Alternatively, the resource obtaining countdown is 5 minutes, and the preset time period is the last 3 minutes.

In an example, the prop duplication operation is configured for representing an interaction operation is performed between the teammate virtual object and the resource redemption point based on the resource redemption prop. For example, a teammate virtual object of the player-controlled virtual object is a virtual object A, and the virtual object A may perform an interaction operation with the resource redemption point, such as the interaction operation between the player-controlled virtual object and the resource redemption point, within the preset time period. This interaction operation is considered as the prop duplication operation. For example, after the virtual object A long presses the interaction control beside the prop verification container at the resource redemption point for verification duration of 5 seconds within the last one minute of the resource obtaining countdown, it is considered that the prop duplication operation is completed.

In an example, based on completion of the prop duplication operation, the resource duplication information may be displayed on the terminal interface of the player-controlled virtual object. The resource duplication information is configured for prompting the teammate virtual object to obtain the prop-holding reward by duplicating the resource redemption prop.

For example, the player-controlled virtual object and the teammate virtual object obtain a same prop-holding reward. For example, each of the player-controlled virtual object and the teammate virtual object obtains 100 virtual resources. Alternatively, each of the player-controlled virtual object and the teammate virtual object can extract from the virtual match at a non-extraction point, or the like.

In an example, the player-controlled virtual object and the teammate virtual object may alternatively obtain different prop-holding rewards. For example, the player-controlled virtual object obtains 100 virtual resources, and the teammate virtual object obtains 90 virtual resources.

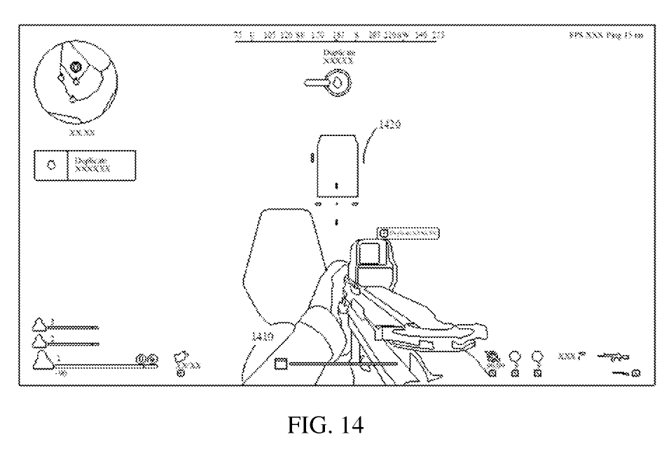

FIG. 14 is a schematic diagram of an interface showing that a teammate virtual object performs a prop duplication operation within a preset time period of a resource obtaining countdown. After a teammate virtual object 1410 long presses an interaction control beside a prop verification container 1420 for verification duration within a preset time period, it is considered that a prop duplication operation is completed.

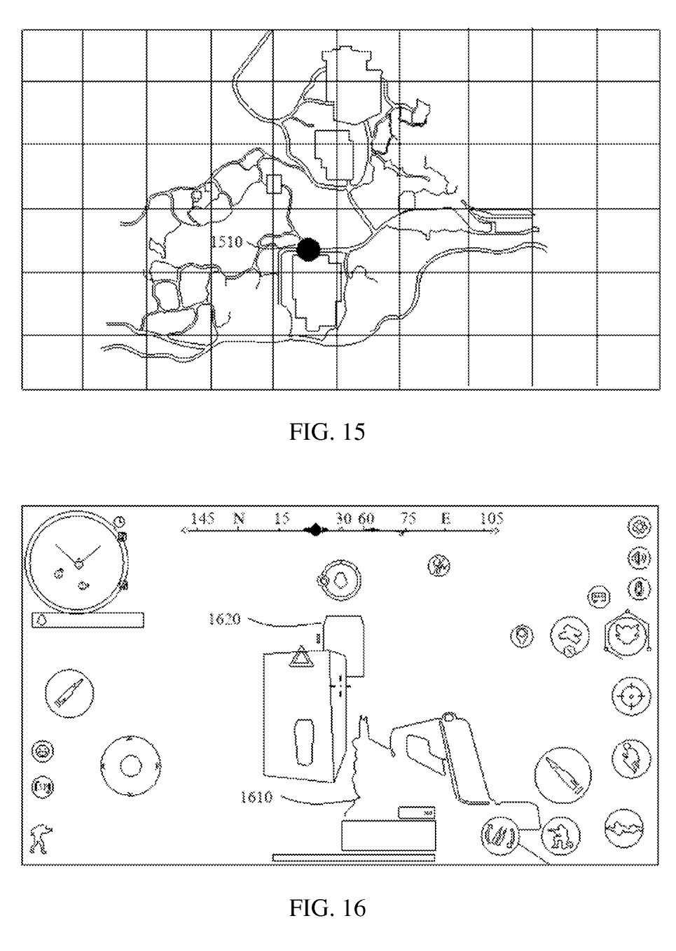

In some examples, after the player-controlled virtual object places the resource redemption prop in the prop verification container, the player-controlled virtual cannot take out the resource redemption prop again, and another virtual object also cannot take out the resource redemption prop. Therefore, the position of the prop identifier corresponding to the resource redemption prop on the virtual map is fixed. As shown in FIG. 15, a prop identifier 1510 is fixed at a position of a prop verification container on a virtual map.

The foregoing is merely exemplary. This is not limited in the examples of this application.

Operation 1320: Display a countdown reset prompt in response to an opponent virtual object performs a prop verification operation during the resource obtaining countdown.

In an example, in addition to defeating the player-controlled virtual object before the resource redemption prop is placed, during the resource obtaining countdown, the opponent virtual objects can contend for the ownership of the resource redemption prop in another manner.

For example, at any time before the resource obtaining countdown ends, the opponent virtual object completes interaction with the prop verification container to perform a process of "counter-decryption" (for example, approaching the interaction control beside the prop verification container for 5 seconds). In this case, the resource obtaining countdown can be reset, and the resource obtaining countdown is bound to the opponent virtual object. That is, the opponent virtual object obtains the prop-holding reward after the resource obtaining countdown ends.

FIG. 16 is a schematic diagram of an interface of an opponent virtual object. An opponent virtual object 1610 may interact with a prop verification container 1620 to implement a process of resetting a resource obtaining countdown. In this process, the opponent virtual object can snatch ownership of a resource redemption prop.

That is, when the opponent virtual object resets the resource obtaining countdown, the countdown reset prompt is configured for representing that the ownership of the resource redemption prop belongs to the opponent virtual object.

In an example, a teammate of the opponent virtual object who completes the counter-decryption process also needs to complete a "duplication" process within the preset time period of the resource obtaining countdown, to obtain a same prop-holding reward after the resource obtaining countdown ends.

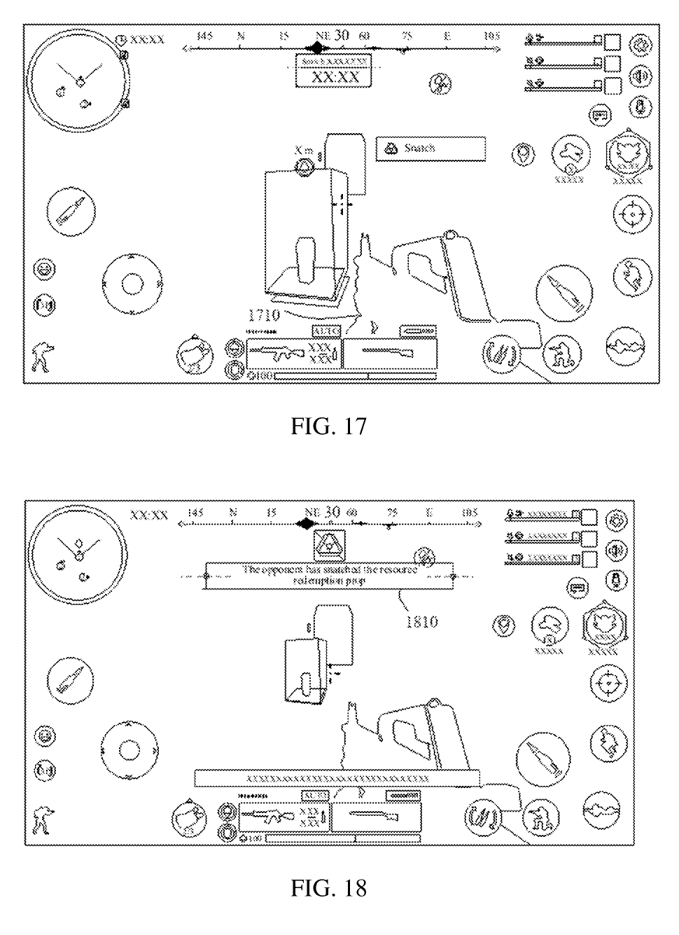

FIG. 17 is a schematic diagram of an interface of a teammate of an opponent virtual object. After the opponent virtual object interacts with the prop verification container to implement a process of resetting the resource obtaining countdown, a teammate 1710 of the opponent virtual object obtains a same prop-holding reward based on a replication process after the resource obtaining countdown ends.

In an example, after any player completes "counter-decryption", all players in the virtual match are notified by broadcasting. For example, as shown in FIG. 18, after the opponent virtual object completes "counter-decryption", broadcast content 1810 of "The opponent has snatched the resource redemption prop", is displayed on terminal interfaces of the player-controlled virtual object and the teammate virtual object. After the opponent virtual object completes "counter-decryption", broadcast content of "Our side has snatched the resource redemption prop", is displayed on terminal interfaces of the opponent virtual object and the teammate of the opponent virtual object. Broadcast content of "Ownership of the resource redemption prop has changed", is displayed on a terminal interface of another virtual object, or the like.

The foregoing is merely exemplary. This is not limited in the examples of this application.

In conclusion, the resource redemption prop is endowed with a new prop function. When the player-controlled virtual object possesses the ownership of the resource redemption prop, the prop-holding reward corresponding to the resource redemption prop is obtained by controlling the player-controlled virtual object to interact with the resource redemption point. In this process, the opponent virtual object may further contend with the player-controlled virtual object for the ownership of the resource redemption prop, whereby difficulty in obtaining the prop-holding reward is adjusted, the appeal of a game is improved, and gameplay is enriched. This facilitates efficient progress of a virtual match between different players, and improves human-computer interaction efficiency.

In the examples of this application, content of duplicating the prop-holding reward by the teammate virtual object or snatching the prop-holding reward by the opponent virtual object is described. The teammate virtual object can obtain the prop-holding reward based on interaction with the prop verification container during the resource obtaining countdown, whereby a sense of faction belonging between the player-controlled virtual object and the teammate virtual object is strengthened, game correlation among a plurality of players is improved, gameplay is enriched, the appeal of a game is improved, and efficiency of interaction between the plurality of players is enhanced.

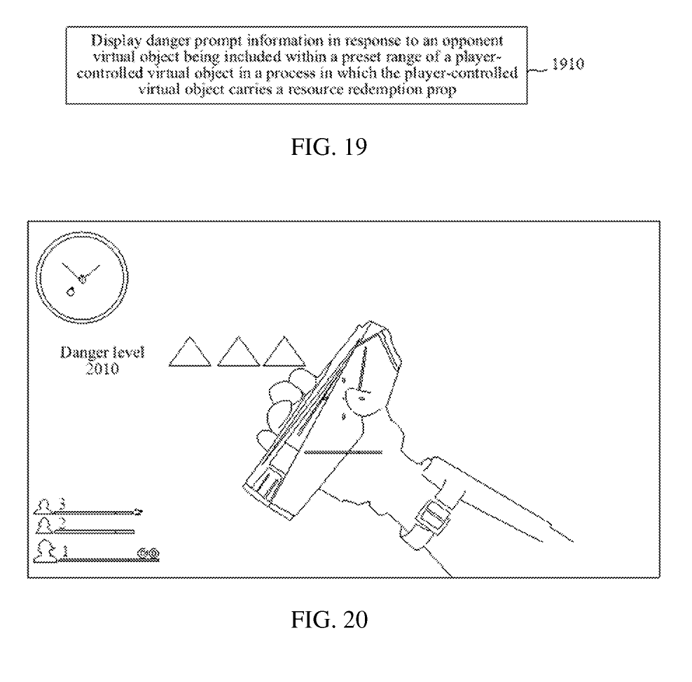

In an example, in a process in which the player-controlled virtual object carries the resource redemption prop, danger prompt information may further be displayed based on a distance between the player-controlled virtual object and the opponent virtual object. For example, as shown in FIG. 19, the example shown in FIG. 3 may further include operation 1910.

Operation 1910: Display danger prompt information in response to the opponent virtual object being included within a preset range of the player-controlled virtual object in a process in which the player-controlled virtual object carries the resource redemption prop.

In some examples, considering that a position of the player-controlled virtual object carrying the resource redemption prop is exposed, to balance game fairness, the danger prompt information may be displayed on the terminal interface of the player-controlled virtual object, to prompt that the opponent virtual object is close to the player-controlled virtual object, and remind the player-controlled virtual object to protect the opponent virtual object and the resource redemption prop, remind the player-controlled virtual object to call the teammate virtual object to provide help, or the like.

In an example, the danger prompt information with a prompt level is displayed based on the distance between the opponent virtual object and the player-controlled virtual object within the preset range. The distance is negatively correlated with the prompt level.

For example, within the preset range, a shorter distance between the opponent virtual object and the player-controlled virtual object indicates a higher prompt level represented by the danger prompt information. Within the preset range, a longer distance between the opponent virtual object and the player-controlled virtual object indicates a lower prompt level represented by the danger prompt information.

In an example, in response to the distance between the opponent virtual object and the player-controlled virtual object being less than or equal to a first distance threshold, the danger prompt information is displayed in a style corresponding to a first distance level interval. In response to the distance between the opponent virtual object and the player-controlled virtual object being greater than the first distance threshold and less than or equal to a second distance threshold, the danger prompt information is displayed in a style corresponding to a second distance level interval.

The first distance threshold is less than the second distance threshold, and the second distance threshold is less than or equal to a specified distance range.

In some examples, at least two prompt identifiers are displayed as the danger prompt information, and a quantity of highlighted prompt identifiers is configured for representing a level intensity of the prompt level.

FIG. 20 is a schematic diagram of an interface showing danger prompt information. Danger prompt information 2010 named "danger level" is seen at a left side of a screen of the player-controlled virtual object. The danger prompt information 2010 can help the player-controlled virtual object learn whether opponent virtual objects exist nearby within the preset range, and approximate distances from the opponent virtual objects. A higher "danger level" indicates a shorter distance from the opponent virtual object. When the "danger level" is 0, it indicates that no opponent virtual object exists nearby within the range.

For example, for the player-controlled virtual object who obtains and carries the resource redemption prop, when the player-controlled virtual object carries the resource redemption prop, distance prompt information is displayed on a terminal interface on which the player-controlled virtual object is logged into. The distance prompt information is configured for prompting a situation in which the opponent virtual object exists within a particular distance range of the player-controlled virtual object, and a distance level (or referred to as a danger level) corresponding to a distance between the player-controlled virtual object and the opponent virtual object.

For example, if at least one opponent virtual object exists in a circular area obtained by using the player-controlled virtual object as a center and a first length as a radius, the danger prompt information is displayed. A corresponding danger level is displayed based on a distance between the opponent virtual object nearest to the player-controlled virtual object and the player-controlled virtual object. A shorter distance between the opponent virtual object and the player-controlled virtual object indicates a higher danger level. The danger prompt information and the danger level change in real time based on the distance between the player-controlled virtual object and the opponent virtual object.

When the player-controlled virtual object carries the resource redemption prop and executes a task, the opponent virtual object may launch an attack to the player-controlled virtual object or snatch the resource redemption prop. If the opponent virtual object snatches the resource redemption prop from the player-controlled virtual object, the distance prompt information is no longer displayed on the terminal interface on which the player-controlled virtual object is logged into. In this case, the player-controlled virtual object and teammate virtual objects perceive position information of the opponent virtual object in real time. The opponent virtual object serves as a player carrying the resource redemption prop. Danger prompt information is displayed on a terminal interface on which the opponent virtual object is logged into. In this case, the danger prompt information is configured for prompting an existence situation of another virtual object within a distance range of the opponent virtual object, a danger level corresponding to a distance between the opponent virtual object and the another virtual object, and the like.

The foregoing is merely exemplary. This is not limited in the examples of this application.

In some examples, a description is made by using an example in which the method is applied to a computer device and the computer device may be a terminal. An account of an opponent virtual object is logged into on the terminal. The method includes: displaying prompt information in response to a resource redemption prop being obtained, and displaying position information of a resource redemption point, the prompt information being configured for prompting the opponent virtual object to contend for ownership of the resource redemption prop; controlling, in response to an object movement operation, the opponent virtual object to move to the resource redemption point indicated by the prompt information; and displaying a resource redemption result in response to a resource redemption operation performed by the opponent virtual object at the resource redemption point when the opponent virtual object possesses the ownership of the resource redemption prop, the resource redemption result indicating reward information obtained by the opponent virtual object through the resource redemption prop.

For example, timing for the opponent virtual object to snatch the ownership of the resource redemption prop may be at least one of the following: in a process in which the player-controlled virtual object carrying the resource redemption prop moves to the resource redemption point indicated by the position information, in a process in which the player-controlled virtual object performs the resource redemption operation at the resource redemption point, in a process in which the player-controlled virtual object performs the prop verification operation, and during the resource obtaining countdown of the player-controlled virtual object.

For related content of the prompt information for the opponent virtual object, the resource redemption operation at the resource redemption point, and the resource redemption result, refer to the foregoing related content of the player-controlled virtual object. Details are not described herein again.

In conclusion, the resource redemption prop is endowed with a new prop function. When the player-controlled virtual object possesses the ownership of the resource redemption prop, the prop-holding reward corresponding to the resource redemption prop is obtained by controlling the player-controlled virtual object to interact with the resource redemption point. In this process, the opponent virtual object may further contend with the player-controlled virtual object for the ownership of the resource redemption prop, whereby difficulty in obtaining the prop-holding reward is adjusted, the appeal of a game is improved, and gameplay is enriched. This facilitates efficient progress of a virtual match between different players, and improves human-computer interaction efficiency.

In the examples of this application, in the process in which the player-controlled virtual object possesses the resource redemption prop, to balance gameplay, the danger prompt information is displayed on the terminal interface of the player-controlled virtual object, to prompt the player-controlled virtual object of the existence situation of the opponent virtual object within the preset range. This helps the player-controlled virtual object performs defense, and also helps the player-controlled virtual object and the teammate virtual object perform joint defense, to provide a fair game mechanism that enables the player-controlled virtual object to obtain effective information within a particular distance range. Therefore, playability of a game is enhanced, and human-computer interaction efficiency is enhanced.

In an example, the reward obtaining method may alternatively be referred to as "a dynamic balance solution for controlling reward obtaining difficulty in a video game". Compared with the related art in which players are limited to attack and being attacked, which results in a monotonous adversarial relationship between the players, and is not beneficial to active participation of the players, the examples of this application provide more diverse game interaction implementation solutions for the players. By controlling the player-controlled virtual object carrying the resource redemption prop to perform targeted interaction with the resource redemption point, the prop-holding rewards in a plurality of forms, such as a virtual redemption resource and a match extraction, reward may be obtained, to enrich gameplay. For example, the foregoing content is described from two aspects: an implementation side and a technical side.

### I. Implementation side

For example, a tactical shooter game is used as an example. A player needs to consume virtual resources in a game to purchase virtual equipment and enter a virtual map. After the game starts, the player randomly appears at some positions on the virtual map, searches for a virtual prop, defeats another player, or completes a specified task, and finally extract to complete a match.

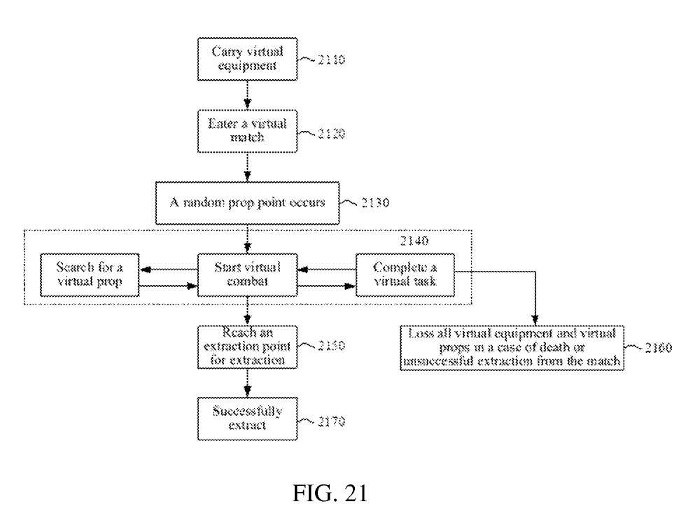

A player who successfully extracts may redeem the collected virtual prop for a virtual resource in the game, to purchase other new equipment. If the player fails to extract, almost all of the virtual equipment on the player and the collected virtual prop are dropped, and cannot be taken out of the game. As shown in FIG. 21, a general procedure of an entire game is presented.

Operation 2110: Carry virtual equipment.

For example, a virtual object may carry virtual equipment before entering a virtual match. The virtual equipment includes content such as a virtual costume, a virtual ornament, a virtual headwear, and a virtual accessory skin.

Operation 2120: Enter a virtual match.

For example, a player may control the virtual object to enter the virtual match through a "game start" control. Alternatively, after a preset game match countdown ends, the virtual object enters the virtual match, or the like.

Operation 2130: A random prop point occurs.

For example, after entering the virtual match, the virtual object controlled by the player may randomly occur at a position point on the virtual map. This is considered as the process in which the random prop point occurs.

Operation 2140: Start a game process.

For example, in a virtual match process, the player may voluntarily perform the game process, or may alternatively perform the game process together with another virtual object, such as voluntarily completing a game task, attacking an opponent virtual object, completing the game task together with a teammate virtual object, or attacking the opponent virtual object together with the teammate virtual object.

In an example, the game process includes three parts: searching for a virtual prop, engaging in a virtual combat, and completing a virtual task.

The virtual prop includes at least one of a plurality of props such as a virtual attack prop, a resource redemption prop, a virtual treatment item, and a virtual defense item.

The virtual combat is configured for representing a process of engaging in combat with the opponent virtual object who does not belong to a same virtual faction. For example, a player-controlled virtual object is controlled to attack at least one opponent virtual object. Alternatively, the player-controlled virtual object is controlled to attack at least one opponent virtual object together with another teammate virtual object. Alternatively, the player-controlled virtual object is controlled to attack an NPC. Alternatively, the player-controlled virtual object is controlled to attack the NPC together with the teammate virtual object.

The virtual task is a task that is set in advance in the virtual match, such as a task of accumulating and obtaining virtual resources or a task of performing interaction with a resource redemption point. This is not limited herein.

Operation 2150: Reach an extraction point for extraction.

For example, the virtual match includes a preset extraction point. After reaching the extraction point, the virtual object may leave the virtual match via a preset extraction channel provided by the extraction point.

In an example, after leaving the virtual match, the virtual object cannot enter the virtual match again. The player needs to do the best to control the virtual object to stay in the virtual match, and prevent the virtual object from being attached and eliminated by the opponent virtual object.

Operation 2160: Loss all virtual equipment and virtual props in a case of death or unsuccessful extraction from the match.

For example, when the virtual object is dead, it is considered that the virtual object is eliminated. Elimination of the virtual object includes: elimination due to an attack from the opponent virtual object; or elimination due to an attack from an NPC; or elimination due to falling within a preset danger range (such as a virtual toxic circle).

For example, when the virtual object is dead, the virtual object cannot extract safely from the match. Alternatively, when a time point at which the virtual object reaches the extraction point exceeds an extraction time period, it is considered that the virtual object cannot extract from the match.

In an example, when the virtual object cannot extract from the virtual match, the virtual object loses all virtual equipment equipped before the virtual match, and also loses the virtual prop collected in the virtual match process.

Operation 2170: Successfully extract.

In an example, the virtual object may safely extract from the extraction point based on completing a preset task. Alternatively, a process of reaching the extraction point may be considered as a successful extraction process, or the like.

That is, operation 2160 and operation 2170 are two mutually exclusive solution results. The solution result is determined by a match situation of the player participating in the virtual match.

The foregoing game process is merely exemplary. In addition to the extraction point, the extraction process may further be implemented as completing the preset task, surviving as a last virtual team, or the like. This is not limited herein.

In an example, different virtual props have different prop functions, a plurality of virtual props are preset in a virtual scene, and there is a probability that the plurality of virtual props includes a resource redemption prop. For example, a virtual match A includes a resource redemption prop, a virtual match B does not include a resource redemption prop, and the like. Alternatively, the plurality of virtual props includes a resource redemption prop, or the like.

For example, the resource redemption prop refers to a virtual prop that can be picked up by the virtual object, and has a bidirectional interactive positioning function. That is, after the resource redemption prop is picked up, the bidirectional interactive positioning function is triggered. Another player may determine, based on the resource redemption prop, a position of the virtual object who picks up the resource redemption prop, and the virtual object may also learn a position of the another virtual object based on a carrying process of the resource redemption prop, and the like.

In an example, an example in which the virtual object carrying the resource redemption prop is the player-controlled virtual object is used. The player-controlled virtual object needs to carry the resource redemption prop to a specified position (such as the resource redemption point) to complete a task, whereby the player-controlled virtual object obtains a special reward (the prop-holding reward).

For example, the special reward includes that after completing the task, the player-controlled virtual object can complete an extraction process from a non-extraction point. For example, after the preset time of the virtual match is reached, even if the player-controlled virtual object is not at the extraction point, the player-controlled virtual object can automatically extract. The special reward may further include a virtual resource and the like.

In some examples, if the resource redemption prop occurs in the virtual match, all players are notified, and a prompt pops up on an upper part of a screen. For example, FIG. 5 shows an effect of a global prompt.

In some examples, after the global prompt is delivered, the position of the resource redemption prop is immediately displayed on virtual maps of the players, and all players can see the position of the resource redemption prop in real time. From this moment, the position of the resource redemption prop is continuously exposed, and after a player reaches the resource redemption point and completes a task to obtain the prop-holding reward, the resource redemption prop is considered to be used and the position is no longer displayed. For example, FIG. 6 shows an effect of prop position exposure.

In some examples, after the player-controlled virtual object picks up the resource redemption prop, a task target is automatically triggered. In this case, the player-controlled virtual object needs to carry the resource redemption prop to the specified position (the resource redemption point), and the teammate virtual object belonging to a same virtual faction may assist the player-controlled virtual object in safely delivering the resource redemption prop.

In an example, two positions are marked on a screen of the player-controlled virtual object who picks up the resource redemption prop as resource redemption points. In this case, the player-controlled virtual object may perform a task execution process based on the resource redemption prop. For example, FIG. 7 shows an effect of position marking.

In some examples, in a process in which the player-controlled virtual object takes out the resource redemption prop, a system may set that the player-controlled virtual object cannot perform any action in the process in which the player-controlled virtual object takes out the resource redemption prop. Therefore, the opponent virtual object may choose to ambush at a place where the resource redemption prop is located, and defeat the player-controlled virtual object in the process in which the player-controlled virtual object takes out the resource redemption prop. For example, FIG. 8 shows an effect of taking out a resource redemption prop.

In some examples, after the resource redemption prop is picked up by the player-controlled virtual object, the system performs global broadcasting to notify all players that someone has successfully picked up the resource redemption prop.

In an example, when performing broadcasting, the system may broadcast only a result indicating that a virtual object obtains the resource redemption prop (that is, does not disclose the player-controlled virtual object), or may broadcast a result indicating that the player-controlled virtual object obtains the resource redemption prop (that is, discloses the player-controlled virtual object, such as disclosing a nickname or an avatar).

For example, in a broadcasting effect (the prop obtaining prompt information) displayed on the terminal interface of the teammate virtual object belonging to the same virtual faction as the player-controlled virtual object, it is prompted that: "Our side has obtained the resource redemption prop"; or "Our teammate X has obtained the resource redemption prop", or the like. In a broadcasting effect displayed on the terminal interface of the opponent virtual object belonging to the virtual faction different from that of the player-controlled virtual object, it is prompted that: "The opponent has obtained the resource redemption prop". FIG. 9 is a schematic diagram of a broadcasting effect of a terminal interface corresponding to an opponent virtual object.

In some examples, positions of the two specified resource redemption points can be seen on the virtual maps of all players. For example, FIG. 10 shows a display effect of position information on a virtual map.

In some examples, before the player-controlled virtual object reaches the resource redemption point and completes the task, the position of the resource redemption prop is continuously exposed on the virtual map, and does not change as the resource redemption prop is picked up. Therefore, when the player-controlled virtual object carries the resource redemption prop to the resource redemption point, the track is exposed, but the teammate virtual object of the prop holder is not exposed. For example, FIG. 11 shows a first perspective of an opponent virtual object.

In some examples, to avoid a problem that the position of the player-controlled virtual object is always learned by the opponent virtual object but the player-controlled virtual object cannot learn the position of the opponent virtual object, the system sets a combat system. That is, although the player-controlled virtual object carrying the resource redemption prop is exposed, the player-controlled virtual object can view prompt information named "danger level" at a left side of the screen. This prompt information helps the player of the player-controlled virtual object learn whether the opponent virtual object exists nearby within a range and an approximate distance from the opponent virtual object. A higher "danger level" indicates a shorter distance from the opponent virtual object. When the "danger level" is 0, it indicates that no opponent virtual object exists nearby within the range.

For example, FIG. 20 shows a display effect of prompt information. The position of the resource redemption prop is displayed in real time, the track of the player-controlled virtual object is exposed when the player-controlled virtual object moves to the resource redemption point to perform the task after picking up the resource redemption prop, and the player-controlled virtual object can also obtain information about the nearby opponent virtual object. The player-controlled virtual object may communicate and collaborate with the teammate virtual object whose position is not exposed, and make good use of the prompt information obtained by the player-controlled virtual object, or may discard the resource redemption prop to confuse the opponent virtual object. In this case, the players on both sides may engage in a game and combat based on asymmetrical information and selection, which makes the combat more interesting.

In some examples, after reaching the resource redemption point, the player-controlled virtual object carrying the resource redemption prop needs to insert the resource redemption prop into a special container at the resource redemption point (for example, approaching the special container and long-pressing an interaction control for 5 s without interruption is considered as successful insertion), to implement an interaction process between the player-controlled virtual object and the resource interaction point. For example, FIG. 12 is a schematic diagram of inserting a resource redemption prop into a special container.

In an example, a countdown starts after the resource redemption prop is inserted. After the countdown ends, the player-controlled virtual object may directly obtain the prop-holding reward. For example, the prop-holding reward includes that the player-controlled virtual object can extract from the virtual match even if the player-controlled virtual object fails to reach the extraction point.

In an example, the teammate virtual object of the player-controlled virtual object who inserts the resource redemption prop into the special container needs to interact with the special container within the last minute of the countdown, to complete a duplication process (for example, approaching the special container and long-pressing the interaction control for 5 seconds). In this case, after the countdown ends, the teammate virtual object can obtain a same reward as the player-controlled virtual object who inserts the resource redemption prop at the beginning. For example, FIG. 14 is a schematic diagram of a replication process performed by a teammate virtual object.

In some examples, after being placed in the special container, the resource redemption prop cannot be taken out again, the prompt information of the "threat level" disappears, and the position of the resource redemption prop on the virtual map is fixed. For example, FIG. 15 shows a presentation effect of a virtual map.

In some examples, when long-pressing the interaction control to place the resource redemption prop, the player-controlled virtual object cannot perform any other action. Therefore, at this moment, the opponent virtual object may choose to ambush at the special container, and defeat the player-controlled virtual object when the player-controlled virtual object carrying the prop reaches the resource redemption point for interaction.

In an example, in addition to defeating the player-controlled virtual object carrying the resource redemption prop before the resource redemption prop is placed, during countdown, another opponent virtual object may snatch the prop-holding reward corresponding to the resource redemption prop in another manner.

For example, at any time before the countdown ends, the opponent virtual object may interact with the special container to implement a process of "counter-decryption" (for example, approaching the special container and long-pressing the interaction control for 5 s). In this case, the countdown can be reset, and the opponent virtual object obtains the reward when the countdown ends. FIG. 16 is a schematic diagram of snatching a resource redemption prop through a process of "counter-decryption".

In addition, another virtual object belonging to a same virtual faction as the opponent virtual object who completes counter-decryption can also obtain the same prop-holding reward after the countdown ends only by completing the "duplication" process within the last one minute. FIG. 17 is a schematic diagram of reminding of obtaining a prop-holding reward through a "duplication" process.

In an example, after any opponent virtual object completes the "counter-decryption" process, all players on the virtual map are notified through broadcasting. FIG. 18 is a schematic diagram of broadcasting a notification indicating that a resource redemption prop has been snatched. That is, in a process in which the player-controlled virtual object interacts with the resource redemption point, an offensive and defensive relationship exists between the players, and offensive and defensive roles can be continually swapped.

The foregoing is merely exemplary. This is not limited in the examples of this application.

### II. Technical side

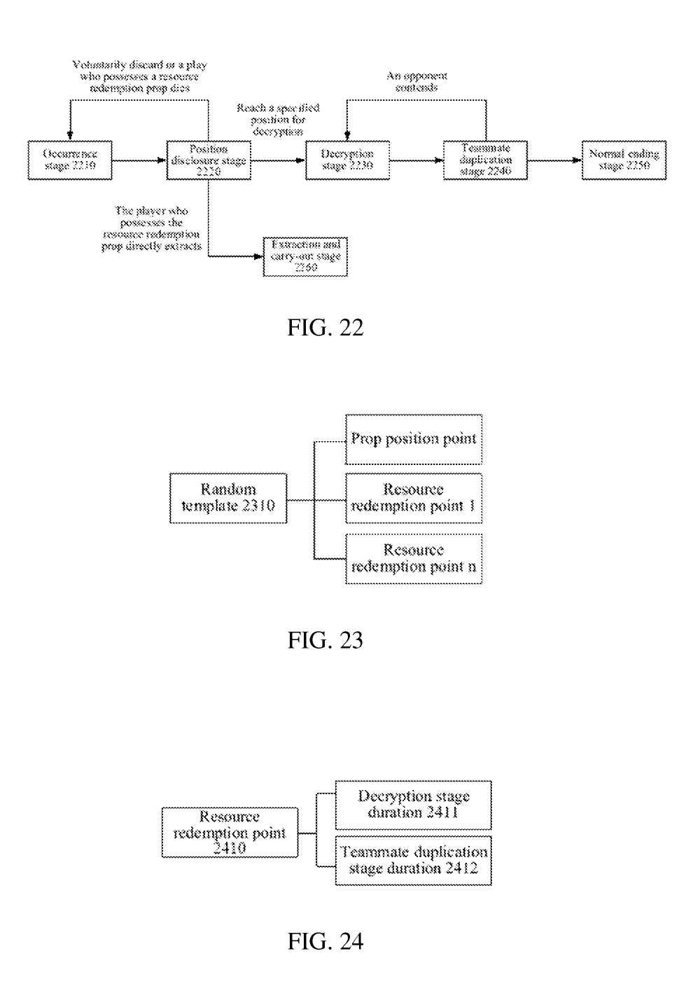

FIG. 22 is a schematic diagram of a technical side. An entire gameplay solution may be divided into the following several stages:
(1) Occurrence stage 2210: In the occurrence stage 2210, a resource redemption prop is spawned or dropped into a virtual scene.
(2) Position disclosure stage 2220: In the position disclosure stage 2220, a player (such as the player-controlled virtual object) picks up and holds the resource redemption prop.
(3) Decryption stage 2230: In the decryption stage 2230, the player who possesses the resource redemption prop brings the resource redemption prop to a specified position for decryption, and completes decryption within a time period.
(4) Teammate duplication stage 2240: In the teammate duplication stage 2240, after a decryption countdown ends, a teammate virtual object of the player who decrypts the resource redemption prop player may duplicate the resource redemption prop at a resource redemption point to obtain a prop-holding reward.
(5) Normal ending stage 2250: In the normal ending stage 2250, a countdown of the teammate duplication stage 2240 ends normally, the resource redemption prop is not snatched by another opponent player, the entire gameplay ends normally, and the player who decrypts the resource redemption prop and the player who duplicates the resource redemption prop obtain the prop-holding reward after the match overs.
(6) Extraction and carry-out stage 2260: In the extraction and carry-out stage 2260, the player who possesses the resource redemption prop does not bring the resource redemption prop to the specified position for decryption, but directly extracts from a battlefield at an extraction point.

Transition between the foregoing stages is implemented based on behavior logic of the player in the game. When the player picks the resource redemption prop in the virtual scene, the gameplay enters the position disclosure stage 2220 from the occurrence stage 2210. In the position disclosure stage 2220, if the player who possesses the resource redemption prop voluntarily discards the resource redemption prop or dies, the gameplay reverts to the occurrence stage 2210. If the player who possesses the resource redemption prop directly goes to the extraction point for extraction, the gameplay enters the extraction and carry-out stage 2260. In an example, another virtual object may continue to perform the virtual match without being controlled by the extraction and carry-out stage 2260.

When the player who possesses the resource redemption prop goes to the resource redemption point for decryption, the gameplay enters the decryption stage 2230. In the decryption stage 2230, the player who decrypts the resource redemption prop and the teammate virtual objects need to wait for completion of the resource obtaining countdown. If the resource redemption prop is snatched by the opponent virtual object in this stage, the resource obtaining countdown restarts, and the gameplay is still in the decryption stage 2230. The gameplay can only enter the teammate duplication stage 2240 when the resource obtaining countdown ends. In the teammate duplication stage, if the resource redemption prop is snatched by the opponent virtual object, the gameplay reverts to the decryption stage 2230 until the countdown of the teammate duplication stage 2240 ends, and then enters the normal ending stage 2250.

In an example, to provide a particular random attribute for occurrence of the resource redemption prop and occurrence of the position of the resource redemption point, a random template may be designed, as shown in FIG. 23.

A random template 2310 includes a single prop position point and several resource redemption points, and the prop position point represents an occurrence point of a resource redemption prop. A plurality of random templates 2310 may be configured in the virtual scene, and a weight value is given to each random template 2310. At the beginning of the game, all the random templates 2310 are collected, and one of the random templates 2310 may be activated based on a random or specified weight. A particular random attribute is provided for the prop position point and the resource redemption point in the foregoing manner of the random template 2310, to improve playability of a game.

In an example, as shown in FIG. 24, decryption stage duration 2411 and teammate duplication stage duration 2412 may be configured for each resource redemption point 2410. In this case, each resource redemption point can control difficulty.

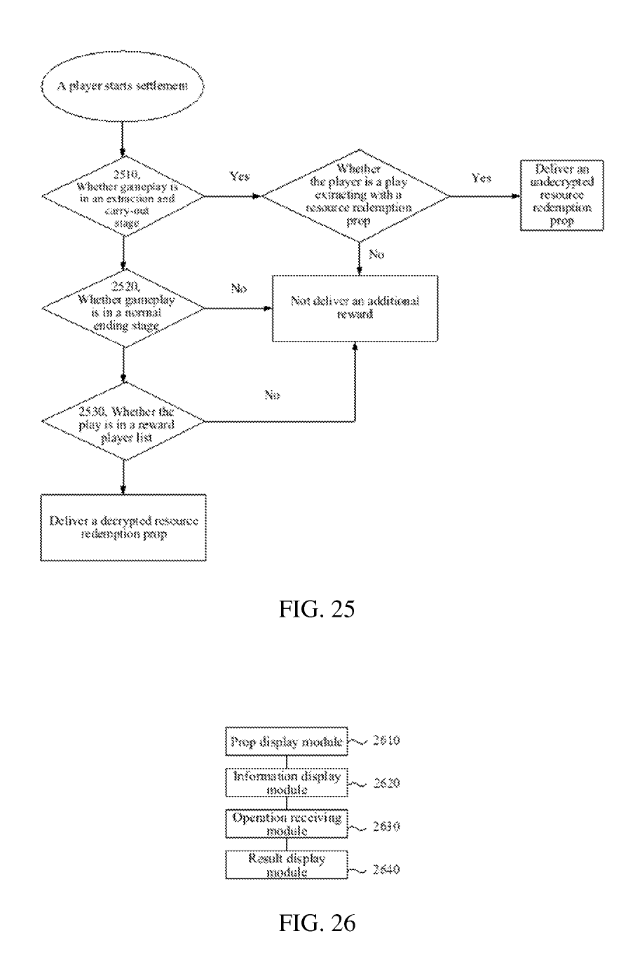

In an example, FIG. 25 is a schematic diagram of determining a gameplay stage. Whether gameplay is in an extraction and carry-out stage 2510, whether the gameplay is in a normal ending stage 2520, and whether a player is in a reward player list 2530 are mainly determined.

If the gameplay finally enters a normal ending stage, a player who successfully decrypts a resource redemption prop and a player who successfully duplicate the resource redemption prop are recorded in the reward player list and marked as eligible for a decrypted prop-holding reward, such as a complete prop-holding reward.

If the gameplay finally enters the extraction and carry-out stage, a player who carries the resource redemption prop and who extracts is recorded and marked as eligible for an undecrypted prop-holding reward, such as a partial prop-holding reward or no prop-holding reward.

When the player exits settlement of a current round of game, if the gameplay is in the extraction and carry-out stage, whether the settlement player is a player carrying the resource redemption prop is determined, and if the settlement player is the player carrying the resource redemption prop, an undecrypted resource redemption prop is delivered. If the gameplay is in the normal ending stage, whether the settlement player is in the reward player list is determined, and if the settlement player is in the reward player list, the decrypted resource redemption prop is delivered. If the settlement player is not in the reward player list, no additional reward is delivered.

In conclusion, the resource redemption prop is endowed with a new prop function. When the player-controlled virtual object possesses the ownership of the resource redemption prop, the prop-holding reward corresponding to the resource redemption prop is obtained by controlling the player-controlled virtual object to interact with the resource redemption point. In this process, the opponent virtual object may further contend with the player-controlled virtual object for the ownership of the resource redemption prop, whereby difficulty in obtaining the prop-holding reward is adjusted, the appeal of a game is improved, and gameplay is enriched. This facilitates efficient progress of a virtual match between different players, and improves human-computer interaction efficiency.

In the examples of this application, through the bidirectional interactive positioning prop, timed contention at the specified point, a new reward carry-out mechanism, a mechanism of controlling reward obtaining through intense adversarial gameplay driven by asymmetric information among players in an extraction shooter game is created. In this solution, a player who voluntarily picks up a prop for a task, or intercepts and ambushes can effectively use his/her own advantages in combat. With no absolute dominance, this fosters a stronger sense of player engagement. In a final stage, a player needs to grasp a position of a special container, launch a targeted attack, defense, and duplicate, to form intense combat.

FIG. 26 is a structural block diagram of a reward obtaining apparatus according to an exemplary example of this application. As shown in FIG. 26, the apparatus includes the following parts: a prop display module 2610, configured to display a resource redemption prop in a virtual scene, the resource redemption prop being configured for obtaining a prop-holding reward after redemption; an information display module 2620, configured to control, in response to a prop obtaining operation, a player-controlled virtual object to obtain a resource redemption prop, and display position information of a resource redemption point, prompt information being displayed from the perspective of an opponent virtual objects after the resource redemption prop is obtained, and the prompt information being configured for prompting the opponent virtual object to contend for ownership of the resource redemption prop; an operation receiving module 2630, configured to control, in response to an object movement operation, the player-controlled virtual object carrying the resource redemption prop to move to the resource redemption point indicated by the position information; and a result display module 2640, configured to display a resource redemption result in response to a resource redemption operation performed by the player-controlled virtual object at the resource redemption point, the resource redemption result indicating reward information obtained by the player-controlled virtual object by redeeming the resource redemption prop.

In an example, the result display module 2640 is further configured to receive, in response to the player-controlled virtual object reaching the resource redemption point based on the object movement operation, a prop verification operation for controlling interaction between the player-controlled virtual object and the resource redemption point, the prop verification operation being configured for verifying the resource redemption prop; and display the resource redemption result based on the resource redemption operation in a case that the prop verification operation satisfies a preset verification condition.

In an example, the result displaying module 2640 is further configured to display, in response to the opponent virtual object failing to possess the ownership of the resource redemption prop within verification duration corresponding to the prop verification operation, the resource redemption result based on the resource redemption operation.

In an example, the result display module 2640 is further configured to display a resource obtaining countdown in a case that the prop verification operation satisfies the preset verification condition; and display the resource redemption result in response to the player-controlled virtual object possessing the ownership of the resource redemption prop during the resource obtaining countdown.

In an example, the result display module 2640 is further configured to display a resource obtaining control in response to the player-controlled virtual object possessing the ownership of the resource redemption prop during the resource obtaining countdown, the resource obtaining control being configured to prompt the player-controlled virtual object to obtain the prop-holding reward by redeeming the resource redemption prop; and receive the resource redemption operation for the resource obtaining control, and display the resource redemption result.

In an example, the result display module 2640 is further configured to display resource duplication information in response to a teammate virtual object completing a prop duplication operation within a preset time period of the resource obtaining countdown, the prop duplication operation being configured for representing an interaction process performed between the teammate virtual object and the resource redemption point; and the resource duplication information being configured for prompting the teammate virtual object to obtain the prop-holding reward by duplicating the resource redemption prop.

In an example, the result display module 2640 is further configured to display a countdown reset prompt in response to the opponent virtual object performing the prop verification operation during the resource obtaining countdown, the countdown reset prompt being configured for representing that the ownership of the resource redemption prop belongs to the opponent virtual object.

In an example, the information display module 2620 is further configured to display danger prompt information in response to the opponent virtual object being included within a preset range of the player-controlled virtual object in a process in which the player-controlled virtual object carries the resource redemption prop.

In an example, the information display module 2620 is further configured to display the danger prompt information with a prompt level based on a distance between the opponent virtual object and the player-controlled virtual object within the preset range, the distance being negatively correlated with the prompt level.

In an example, the information display module 2620 is further configured to display at least two prompt identifiers as the danger prompt information, a quantity of highlighted prompt identifiers being configured for representing a level intensity of the prompt level.

In conclusion, the resource redemption prop is endowed with a new prop function. When the player-controlled virtual object possesses the ownership of the resource redemption prop, by controlling the player-controlled virtual object to interact with the resource redemption point, the prop-holding reward corresponding to the resource redemption prop is obtained. In this process, the opponent virtual object may further contend with the player-controlled virtual object for the ownership of the resource redemption prop, whereby difficulty in obtaining the prop-holding reward is adjusted, the appeal of a game is improved, and gameplay is enriched. This facilitates efficient progress of a virtual match between different players, and improves human-computer interaction efficiency.

The reward obtaining apparatus provided in the foregoing examples is only illustrated by taking the division of the foregoing functional modules as an example. In practical application, the foregoing functions may be allocated to and completed by different functional modules according to requirements. In other words, an internal structure of a device is divided into different functional modules, to complete all or some of the functions described above. In addition, the reward obtaining apparatus provided in the foregoing examples and the examples of the reward obtaining method belong to a same conception. For a specific implementation process of the reward obtaining apparatus, refer to the method examples. Details are not described herein again.

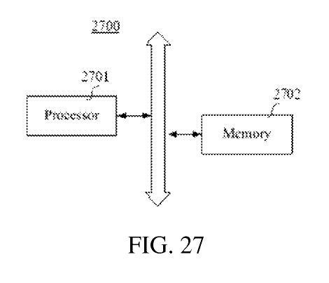

FIG. 27 is a structural block diagram of an electronic device according to an exemplary example of this application. An electronic device 2700 may be a portable mobile terminal, such as a smartphone, an in-vehicle terminal, a tablet computer, an MP3 player, an MP4 player, a notebook computer, or a desktop computer. The terminal device 2700 may alternatively be referred to as another name such as user equipment, a portable terminal, a laptop terminal, or a desktop terminal.

The terminal device 2700 includes: a processor 2701 and a memory 2702.

The processor 2701 may include one or more processing cores, such as a 4-core processor or an 8-core processor. The processor 2701 may be implemented in at least one hardware form of a digital signal processor (DSP), a field-programmable gate array (FPGA), and a programmable logic array (PLA). The processor 2701 may alternatively include a main processor and a coprocessor. The main processor refers to a processor configured to process data in an awake state, and is also referred to as a central processing unit (CPU). The coprocessor refers to a low power consumption processor configured to process data in a standby state. In some examples, the processor 2701 may be integrated with a graphics processing unit (GPU). The GPU is configured to render and draw content that needs to be displayed on a display screen. In some examples, the processor 2701 may further include an artificial intelligence (AI) processor. The AI processor is configured to process computing operations related to machine learning.

The memory 2702 may include one or more computer-readable storage media. The computer-readable storage medium may be non-transitory. The memory 2702 may further include a high-speed random-access memory (RAM) and a nonvolatile memory, such as one or more disk storage devices or flash storage devices. In some examples, a non-transitory computer-readable storage medium in the memory 2702 is configured to store at least one instruction. The at least one instruction is executed by the processor 2701 to implement the reward obtaining method provided in the examples of this application.

In some examples, the electronic device 2700 further includes one or more sensors. The one or more sensors include, but are not limited to, a proximity sensor, a gyroscope sensor, and a pressure sensor.

The proximity sensor, also referred to as a distance sensor, is typically disposed on a front panel of the electronic device 2700. The proximity sensor is configured to acquire a distance between a user and a front surface of the electronic device 2700. The gyroscope sensor may detect a body direction and a rotation angle of the electronic device 2700. The gyroscope sensor may cooperate with the acceleration sensor to acquire a 3D action performed by the user on the computer device 2700. The processor 2701 may implement the following functions based on data acquired by the gyroscope sensor: motion sensing (such as changing a user interface (UI) through a tilt operation of the user), image stabilization during shooting, game control, and inertial navigation. The pressure sensor may be disposed at a side frame of the electronic device 2700 and/or a lower layer of a display screen. When disposed at the side frame of the terminal 2700, the pressure sensor can detect a holding signal of the user on the terminal 2700. The processor 2701 performs left/right-hand recognition or a quick operation based on the holding signal acquired by the pressure sensor. When the pressure sensor is disposed on the low layer of the display screen the processor 2701 controls an operable control on the UI based on a pressure operation performed by the user on the display screen. The operable control includes at least one of a button control, a scroll-bar control, an icon control, and a menu control.

In some examples, the electronic device 2700 further includes other components. A person skilled in the art may understand that the structure shown in FIG. 27 does not constitute a limitation on the electronic device 2700, and the electronic device may include more or fewer components than those shown in the figure, some components are combined, or a different component arrangement is adopted.

This application further provides a computer device. The computer device may be implemented as the terminal or the server shown in FIG. 2. The computer device includes a processor and a memory. The memory has at least one program stored therein. The at least one program is loaded and executed by the processor to implement the reward obtaining method provided in the foregoing method examples.

This application further provides a computer-readable storage medium. The computer-readable storage medium has at least one computer program stored therein. The at least one computer program is loaded and executed by a processor, to implement the reward obtaining method provided in the foregoing method examples.

This application further provides a computer program product or a computer program. The computer program product or the computer program includes computer instructions. The computer instructions are stored in a computer-readable storage medium. A processor of a computer device reads the computer instructions from the computer-readable storage medium, and executes the computer instructions, to cause the computer device to perform the reward obtaining method according to any one of the foregoing examples.

In an example, the computer-readable storage medium may include: a read-only memory (ROM), a RAM, a solid-state drive (SSD), an optical disc, or the like. The RAM may include a resistance RAM (ReRAM) and a dynamic RAM (DRAM). The sequence numbers of the foregoing examples of this application are merely for description purpose but do not imply the preference among the examples.

A person of ordinary skill in the art may understand that all or some of the steps of the foregoing examples may be implemented by using hardware, or may be implemented by a program instructing relevant hardware. The program may be stored in a computer-readable storage medium. The storage medium may be a read-only memory, a magnetic disk, an optical disc, or the like. The foregoing descriptions are merely some examples of this application, but are not intended to limit this application. Any modification, equivalent replacement, or improvement made within the spirit and principle of this application fall within the scope of protection of this application.

What is claimed is:

1. A method, performed by a computer device and comprising:
displaying a resource redemption prop in a virtual scene, the resource redemption prop being configured for obtaining a prop-holding reward after redemption;
controlling, in response to a prop obtaining operation, a player-controlled virtual object to obtain the resource redemption prop, and displaying position information of a resource redemption point;
after the resource redemption prop is obtained, displaying prompt information from the perspective of an opponent virtual object, the prompt information being configured for prompting the opponent virtual object to contend for ownership of the resource redemption prop;
controlling, in response to an object movement operation, the player-controlled virtual object carrying the resource redemption prop to move to the resource redemption point indicated by the position information; and
displaying a resource redemption result in response to a resource redemption operation performed by the player-controlled virtual object at the resource redemption point, the resource redemption result indicating reward information obtained by the player-controlled virtual object by redeeming the resource redemption prop.

2. The method according to claim 1, wherein the displaying a resource redemption result in response to a resource redemption operation performed by the player-controlled virtual object at the resource redemption point comprises:
receiving, in response to the player-controlled virtual object reaching the resource redemption point based on the object movement operation, a prop verification operation for controlling interaction between the player-controlled virtual object and the resource redemption point, the prop verification operation being configured for verifying the resource redemption prop; and
displaying the resource redemption result based on the resource redemption operation based on the prop verification operation satisfying a preset verification condition.

3. The method according to claim 2, wherein the displaying the resource redemption result based on the resource redemption operation comprises:
displaying, in response to the opponent virtual object failing to possess the ownership of the resource redemption prop within verification duration corresponding to the prop verification operation, the resource redemption result based on the resource redemption operation.

4. The method according to claim 2, wherein the displaying the resource redemption result based on the resource redemption operation comprises:
displaying a resource obtaining countdown in a case that the prop verification operation satisfies the preset verification condition; and
displaying the resource redemption result in response to the player-controlled virtual object possessing the ownership of the resource redemption prop during the resource obtaining countdown.

5. The method according to claim 4, further comprising:
displaying a resource obtaining control in response to the player-controlled virtual object possessing the ownership of the resource redemption prop during the resource obtaining countdown, the resource obtaining control being configured to prompt the player-controlled virtual object to obtain the prop-holding reward by redeeming the resource redemption prop; and
receiving the resource redemption operation for the resource obtaining control, and displaying the resource redemption result.

6. The method according to claim 4, further comprising:
displaying resource duplication information in response to a teammate virtual object completing a prop duplication operation within a preset time period of the resource obtaining countdown, the prop duplication operation being configured for representing an interaction process performed between the teammate virtual object and the resource redemption point; and the resource duplication information being configured for prompting the teammate virtual object to obtain the prop-holding reward by duplicating the resource redemption prop.

7. The method according to claim 4, further comprising:
displaying a countdown reset prompt in response to the opponent virtual object performing the prop verification operation during the resource obtaining countdown, the countdown reset prompt being configured for representing that the ownership of the resource redemption prop belongs to the opponent virtual object.

8. The method according to claim 1, further comprising:
displaying danger prompt information in response to the opponent virtual object being included within a preset range of the player-controlled virtual object in a process in which the player-controlled virtual object carries the resource redemption prop.

9. The method according to claim 8, wherein the displaying danger prompt information in response to the opponent virtual object being comprised within a preset range of the player-controlled virtual object comprises:
displaying the danger prompt information with a prompt level based on a distance between the opponent virtual object and the player-controlled virtual object within the preset range, the distance being negatively correlated with the prompt level.

10. The method according to claim 9, wherein the displaying the danger prompt information with a prompt level comprises:
displaying at least two prompt identifiers as the danger prompt information, a quantity of highlighted prompt identifiers being configured for representing a level intensity of the prompt level.

11. A computer device, comprising a processor and a memory, the memory having at least one program stored therein, wherein the at least one program is executed by the processor to cause the computer device to:
display a resource redemption prop in a virtual scene, the resource redemption prop being configured for obtaining a prop-holding reward after redemption;
control, in response to a prop obtaining operation, a player-controlled virtual object to obtain the resource redemption prop, and display position information of a resource redemption point,
after the resource redemption prop is obtained, display prompt information from the perspective of an opponent virtual object, the prompt information being configured for prompting the opponent virtual object to contend for ownership of the resource redemption prop;
control, in response to an object movement operation, the player-controlled virtual object carrying the resource redemption prop to move to the resource redemption point indicated by the position information; and
display a resource redemption result in response to a resource redemption operation performed by the player-controlled virtual object at the resource redemption point, the resource redemption result indicating reward information obtained by the player-controlled virtual object by redeeming the resource redemption prop.

12. The computer device according to claim 11, wherein to display the resource redemption result in response to the resource redemption operation performed by the player-controlled virtual object at the resource redemption point, the at least one program is loaded and executed by the processor to cause the computer device to:
receive, in response to the player-controlled virtual object reaching the resource redemption point based on the object movement operation, a prop verification operation for controlling interaction between the player-controlled virtual object and the resource redemption point, the prop verification operation being configured for verifying the resource redemption prop; and
display the resource redemption result based on the resource redemption operation based on the prop verification operation satisfying a preset verification condition.

13. The computer device according to claim 12, wherein to display the resource redemption result based on the resource redemption operation, the at least one program is executed by the processor to cause the computer device to:
display a resource obtaining countdown in a case that the prop verification operation satisfies the preset verification condition; and
display the resource redemption result in response to the player-controlled virtual object possessing the ownership of the resource redemption prop during the resource obtaining countdown.

14. The computer device according to claim 13, wherein the at least one program is further executed by the processor to cause the computer device to:
display resource duplication information in response to a teammate virtual object completing a prop duplication operation within a preset time period of the resource obtaining countdown, the prop duplication operation being configured for representing an interaction process performed between the teammate virtual object and the resource redemption point; and the resource duplication information being configured for prompting the teammate virtual object to obtain the prop-holding reward by duplicating the resource redemption prop.

15. The computer device according to claim 11, wherein the at least one program is executed by the processor to cause the computer device to:
display danger prompt information in response to the opponent virtual object being included within a preset range of the player-controlled virtual object in a process in which the player-controlled virtual object carries the resource redemption prop.

16. A non-transitory computer-readable storage medium storing instructions that, when executed by a processor, cause a computer device to:
display a resource redemption prop in a virtual scene, the resource redemption prop being configured for obtaining a prop-holding reward after redemption;
control, in response to a prop obtaining operation, a player-controlled virtual object to obtain the resource redemption prop, and display position information of a resource redemption point,
after the resource redemption prop is obtained, display prompt information from the perspective of an opponent virtual object, the prompt information being configured for prompting the opponent virtual object to contend for ownership of the resource redemption prop;
control, in response to an object movement operation, the player-controlled virtual object carrying the resource redemption prop to move to the resource redemption point indicated by the position information; and
display a resource redemption result in response to a resource redemption operation performed by the player-controlled virtual object at the resource redemption point, the resource redemption result indicating reward information obtained by the player-controlled virtual object by redeeming the resource redemption prop.

17. The non-transitory computer-readable storage medium according to claim 16, wherein to display the resource redemption result in response to the resource redemption operation performed by the player-controlled virtual object at the resource redemption point, the instructions, when executed by the processor, cause the computer device to:
receive, in response to the player-controlled virtual object reaching the resource redemption point based on the object movement operation, a prop verification operation for controlling interaction between the player-controlled virtual object and the resource redemption point, the prop verification operation being configured for verifying the resource redemption prop; and
display the resource redemption result based on the resource redemption operation based on the prop verification operation satisfying a preset verification condition.

18. The non-transitory computer-readable storage medium according to claim 17, wherein to display the resource redemption result based on the resource redemption operation, the instructions, when executed by the processor, cause the computer device to:
display a resource obtaining countdown in a case that the prop verification operation satisfies the preset verification condition; and
display the resource redemption result in response to the player-controlled virtual object possessing the ownership of the resource redemption prop during the resource obtaining countdown.

19. The non-transitory computer-readable storage medium according to claim 16, wherein the instructions, when executed by the processor, cause the computer device to:
display danger prompt information in response to the opponent virtual object being included within a preset range of the player-controlled virtual object in a process in which the player-controlled virtual object carries the resource redemption prop.

20. The non-transitory computer-readable storage medium according to claim 19, wherein the instructions, when executed by the processor, cause the computer device to:
display the danger prompt information with a prompt level based on a distance between the opponent virtual object and the player-controlled virtual object within the preset range, the distance being negatively correlated with the prompt level.
